(19) United States
(12) Patent Application Publication
(10) Pub. No.: US 2020/0068853 A1
(43) Pub. Date: Mar. 5, 2020

(54) NETWORK-BASED PET TRACKING AND REPORTING SYSTEM

(71) Applicant: Sergio Radovcic, Phoenix, AZ (US)

(72) Inventor: Sergio Radovcic, Phoenix, AZ (US)

(21) Appl. No.: 16/381,933

(22) Filed: Apr. 11, 2019

Related U.S. Application Data
(63) Continuation-in-part of application No. 16/122,491, filed on Sep. 5, 2018.
Application No. 16/122,491 is a continuation-in-part of application No. 16/157,725, filed on Oct. 11, 2018.

(51) Int. Cl. A01K 29/00; A01K 7/00; A01K 5/01; H04M 1/725

(52) U.S. Cl. CPC A01K 29/005; H04M 1/72561; A01K 5/0114; A01K 7/00

(57) ABSTRACT

A pet wellness tracking system is provided including at least one electronic tracking device secured to a pet, the tracking device having wireless data transfer capability to transfer data to a second electronic device such as a pet owner's smart phone, at least one first electronic volume measurement device secured to or otherwise fitted to a feeding bowl and or watering bowl, the volume measurement device having wireless data transfer capability to transfer data to the second electronic device, and a second electronic volume measurement device having wireless data transfer capability to transfer data to the second electronic device, the combination of devices providing motion tracking over distance and time, caloric burn rate over tracked time, and one or more categories of weight monitoring over time.

### CROSS-REFERENCE TO RELATED DOCUMENTS

This US patent application claims priority as a continuation in part to U.S. application Ser. No. 16/122,491 filed on Sep. 5, 2018 which also claims priority herein as a continuation in part of Ser. No. 16/157,725, filed on Oct. 11, 2018. Both of the US patent applications mentioned above are claimed herein in their entirety at least by reference.

### BACKGROUND OF THE INVENTION

### 1. Field of the Invention

The present invention is in the field of pet physical and nutritional fitness and pertains particularly to methods and apparatus for tracking general activity of pets walking with their owners and providing recommendations relating to nutritional needs for tracked pets.

### 2. Discussion of the State of the Art

In the field of physical fitness for humans, maintaining physical health and fitness is a concerted passion for humans all over the world. Aside from user-operated fitness machines, many consumer products that have been developed to help activities and pursue goals related to fitness state. These products include mobile and often wearable electronics devices for tracking activity and certain states of a user performing the tracked activity at the time.

Pets like dogs, for example, are also dependent on correct nutrition concerning dog food and any supplemental nutritional needs the dog may have. At the time of this writing, people in the US own approximately 89 million dogs. That figure represents an increase of more than 20 million animals over the last 17 years. More recently, a great effort to improve nutrition and health for pets has led to a booming pet food and supplement industry that markets special dog food, formulas for certain breeds based on known third party data about those breeds. Likewise a host of supplemental products that treat conditions like canine arthritis, ear infections, grain allergies, canine asthma, and canine forms of cancer among others.

Most pet owners make regular visits to a veterinarian. This is especially the case of dog owners making sure the animal gets appropriate shots and vaccines for licensing purposes and so that maladies such as arthritis, cancer, and other health problems can be spotted and treated. Some pet owners are not knowledgeable about what is best to feed or not feed their pets or how much to feed their pets. Some pet owners are not knowledgeable about the heat and cold temperatures their pets can or cannot handle. For dogs, canine DNA can predict what risks a pet may have when they grow older such as hip dysplasia for some breeds, arthritis for others, yeast infections for others, etc. Though this third party information is readily available to pet owners, many do not look into this type of information until after a physical sign of a malady is present in their pets.

Pets require exercise to burn off energy and to maintain a natural metabolism. Dog owners, for example regularly walk their animals, and take them to a park or other place to run free such as with a working dog. Because of size differences and breed differences in dogs for example, norms for heart rate, blood pressure, body temperature, agility state, endurance state, and hydration requirements may vary from breed to breed. Many owners have routine practices with their pets that are extremely unhealthy for them and can lead to untimely death of the animal. One example is feeding table scraps to pets over time coupled with little or no regular exercise causing obesity in the animals generally leading to an early death.

Modular electronics devices for tracking physical activity in people are known to be able to track distance and time, running or walking, monitor heart rates, blood pressures, sweat rates, breathing rates, and can calculate simple results such as the number of calories burned, electrolyte loss, and so on. Mobile phone applications have been created that enable a user (person) being tracked to upload data to a remote server where the data may be processed and recommendations may be later sent to the user being tracked. Some of these products include but are not limited to running watches, mobile phone apps, such as RunKeeper or Strava, or like activity trackers, such as FitEit or Jawbone.

It has occurred to the inventor that electronic activity trackers may be modified or originally designed for application to a pet such as a canine to monitor motion including steps, distance of travel, time of travel, etc. It has also occurred to the inventor that people who exercise their animals could be benefited by having access on demand to current physical state fitness data of their animals, and access to timely recommendations about nutrition and health practice relative to those tracked animals.

Therefore what is clearly needed is a network-based data tracking and nutritional advice and fulfillment system for pets that combines tracked fitness data with first-party held data, third-party held data, and knowledge data to create and communicate interactive recommendations and notifications to the owner that are highly personalized for the animal.

### SUMMARY OF THE INVENTION

A pet wellness tracking system is provided and includes at least one electronic tracking device secured to a pet, the tracking device having wireless data transfer capability to transfer data to a second electronic device, a first set of coded instructions on a non transitory medium coupled to or otherwise hosted by the at least one tracking device, the instructions causing the device when powered on to record at least motion data of the pet over time and transfer the data in a push mode or in a pull mode to the second device, at least one first electronic volume measurement device secured to or otherwise fitted to a feeding bowl and or watering bowl, the volume measurement device having wireless data transfer capability to transfer data to the second electronic device, a second set of coded instructions on a non-transitory medium coupled to or otherwise hosted by the at least one volume measurement device, the instructions causing the device when powered on to record at least volume data of the contents in the bowl over time and transfer the data in a push mode or in a pull mode to the second device, a second electronic volume measurement device having wireless data transfer capability to transfer data to the second electronic device, a third set of coded instructions on a non-transitory medium coupled to or otherwise hosted by the second electronic volume measurement device, the instructions causing the device to record volume data of the pet standing or sitting on the device and transfer that data in a push or a pull mode to the second device, and a fourth set of coded instructions on one or more non-transitory mediums coupled to or otherwise hosted by one or more servers on a data network accessible to the second device through network access capability, the instructions causing the one or more servers to receive the recorded data from the second device over the network, process that data in light of other available data, and return data results, notifications and recommendations to a network location accessible to the second device.

In one embodiment, the network is the Internet network and the wireless transfer network is one of a Bluetooth™ network, a wireless fidelity (WiFi) network, or a wireless carrier network (WCN). In a variation of this embodiment, the pet is a dog. In another variation of this embodiment, at least one electronic tracking device attaches to the dog collar and tracks at least motion, time of motion, and elevation. In a further variation of this embodiment, there are two additional tracking devices, one worn on an upper front leg, and one worn on an upper hind leg and track at least motion and position relative to one another.

In one embodiment, the at least one first electronic volume measurement device is an electronic scale that records weight of food or water in the bowl and tracks volume loss over time. In one embodiment, the second device is a smart phone operated by the pet's owner, the smart phone capable of network access and browser-based access to network resources. In a variation of this embodiment, the network location is a pet lab data archive hosted by a web service the pet's owner subscribes to. In a further variation of this embodiment, the pet owner accesses pet lab data through the smart phone and a browser-based application.

In one embodiment, processing consults third-party held data and or resident knowledge based data before finalizing results, notifications, and recommendations to be returned. In one embodiment, the second electronic volume measurement device is a biometric-capable digital weigh scale. In one embodiment, recommendations include introductions to nutritional food mixes, supplements, or other products, the recommendations including at least one executable network link to a least one secure transactional web interface for purchasing a product or service.

In one embodiment, the network access capability of the second device is a wireless Internet capability. In one embodiment, some results are returned after analysis of gait data of the pet. Exemplary to this embodiment, a predicted result is a goal weight of the pet. In one embodiment, the first volume measuring device supports a stock bowl placed thereon or fitted therein and calculates the weight of the empty bowl subtracting that weight from total weight to report correct volume of contents.

In another embodiment, the stock bowl is supported by a rim around the top of the first volume measuring device, the bottom surface of the bowl contacting the scale surface of the first volume measuring device within the physical rim boundary. In a further embodiment, the stock bowl is supported by a three or more adjustable arm stops mounted to the annular surface of the first volume measuring device in equally spaced pattern and wherein the bowl is placed down on the scale surface of the first volume measuring device while the stops are adjusted to make contact above the plane of the scale surface to keep the bowl in place on the first volume measurement device.

In one embodiment, the first volume measuring device further includes at least one motion sensor that detects the vibrations made by a pet eating or drinking, the detection thereof in low power mode cause the device to boot to normal operation. In to one embodiment, other data includes product data describing one or more accessories worn by a pet or a harnessed vehicle attached to a pet.

### BRIEF DESCRIPTION OF THE SEVERAL VIEWS OF THE DRAWINGS

FIG. 1 is an architectural overview of a pet monitoring and fulfillment network according to one embodiment of the present invention.

FIG. 2a is a profile view of the motion tracking device of FIG. 1 mounted to a collar on a dog.

FIG. 2b is a side elevation view of a dog wearing the motion tracker device of FIG. 2A in communication with one or more additional devices according to an embodiment of the present invention.

FIG. 3 is a block diagram depicting general electronic components of the tracking device of FIG. 1.

FIG. 4 is a block diagram depicting basic domains and end points of the pet monitoring and fulfillment network of the present invention.

FIG. 5A is a side elevation view of a bowl scale device analogous to the bowl scale device of FIG. 1.

FIG. 5B is a top view of the bowl scale device of FIG. 5A.

FIG. 5C is a side view of a scale device functioning as a bowl scale device according to an alternate embodiment of the present invention.

FIG. 6 is a block diagram depicting electronic components of the bowl scale device of FIG. 5A, 5B or of 5C.

FIG. 7 is an overhead view of a biometric digital animal weigh scale according to an embodiment of the present invention.

FIG. 8 is a block diagram depicting general electronics components of the animal weigh scale of FIG. 7.

FIG. 9 is a process flow chart depicting steps for setting up the service for tracking for the first time according to an embodiment of the invention.

FIG. 10 is a process flow chart depicting steps for tracking motion, recording special moments for publishing, and receiving recommendations and or notifications based on data tracked and analyzed.

FIG. 11 is a block diagram depicting a processing input model according to an embodiment of the present invention.

FIG. 12 is a block diagram depicting an exemplary knowledge base and knowledge base categories of held data.

FIG. 13 is a block diagram depicting first series of exemplary screen shots of the phone application of FIG. 1 enabling interaction in getting started with the service of the invention.

FIG. 14 is a block diagram depicting a second series of exemplary screen shots of the phone application of FIG. 1 further enabling the same interactive process.

FIG. 15 is a block diagram depicting a third series of exemplary screen shots further enabling the same interactive process.

FIG. 16 is a block diagram depicting a fourth series of exemplary screen shots displaying feeding and weigh-in schedule reminders and a home screen depicting total results data, total time tracked, and other interactive links to other useful data and advertised products.

FIG. 17 is a process flow chart depicting steps for processing collected data and processing the data for results and recommendations or notifications.

FIG. 18 is a block diagram depicting processor access to data over the fulfillment network.

FIG. 19 is a process flow chart depicting steps for predictive analysis based on data to help establish breed according to an embodiment of the present invention.

FIG. 20 is a process flow chart depicting steps for determining an issue through gait analysis of a pet and alerting the pet owner.

### DETAILED DESCRIPTION OF THE INVENTION

The inventors provide a unique network based pet monitoring and fulfillment service and system that analyzes tracked data in light of knowledge data and third party held data and provides analyzed data results along with timely reminders, recommendations, notifications, and owner access over the network for buying advertised pet products and customized pet foods and nutritional supplements and other products. The present invention is described in enabling detail using the following examples, which may describe more than one relevant embodiment falling within the scope of the present invention.

One goal of the present invention is to provide a digital means for pet owners to easily monitor their pet's activity and nutritional stability on an ongoing basis. Another goal of the present invention is to provide a digital means to alert or notify pet owners of possible issues to confront or otherwise consider wherein such issues are discovered in the process of data analysis of tracked data in light of knowledge data and third-party held data. A further goal of the present invention is to enable pet owners to purchase nutritional products where ingredients of same are custom mixed for a pet based on analysis of tracked data in light of knowledge data and third-party held data.

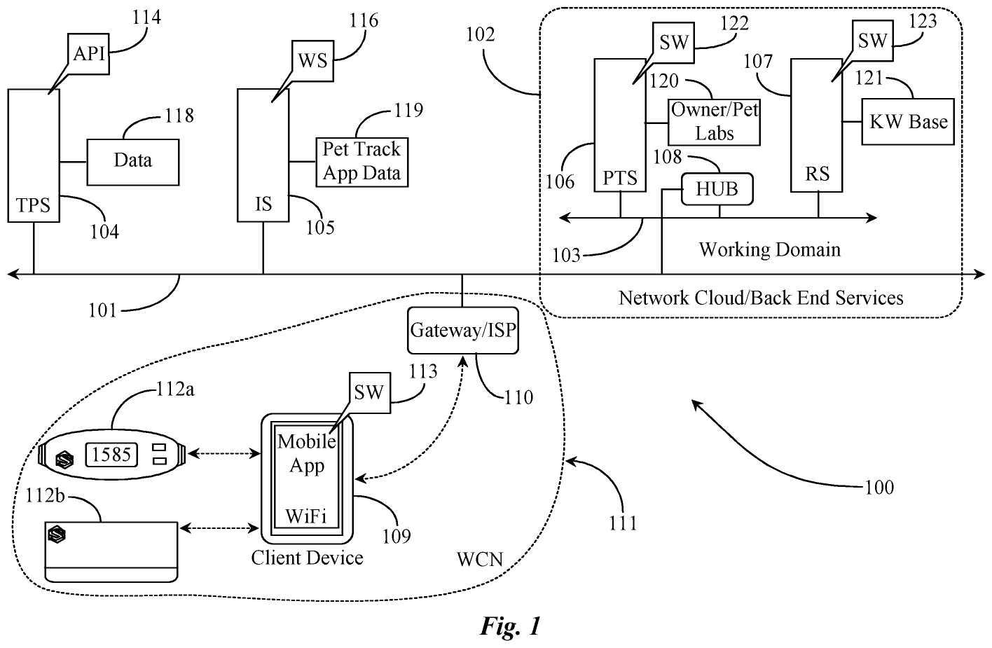

FIG. 1 is an architectural overview of a pet monitoring and fulfillment network 100 according to an embodiment of the present invention. Network 100 includes the well-known Internet network referenced herein as a network backbone 101. Network backbone 101 represents all the lines, equipment, and access points that make up the Internet network including any connected sub-networks. Therefore, there are no geographic limitations on the practice of the present invention. Network backbone 101 may also be referred to in this specification as Internet 101. Backbone 101 may be that of a corporate wide-area-network (WAN), a private WAN, a municipal area network (MAN) without departing from the spirit and scope of the present invention.

Internet 101 is accessible through a gateway 110 hosted by an Internet service provider (ISP). Gateway 110 may bridge a wireless carrier network (WCN) 111 to Internet 101 for connectivity. Internet 101 supports an information server (IS) 105 adapted to serve web pages and websites to users upon user request. Server 105 hosts a website (WS) 116. WS 116 may serve as an access point as part of a web-based service for users to join and subscribe to. Server 105 has connection to a data repository 118 adapted to contain data about subscribed users (clients) also referred to herein as pet owners and data about a client software (SW) application 113 that may be provided as a part of the web-based service for download to potential clients wishing to subscribe to the service.

SW 113 is depicted on a client smart phone 109 that has access to Internet 101, server 105, and website 116, through gateway 110. SW 113 may be downloaded and installed on smart phone 109 by a pet owner subscribing to the service. In one embodiment, the pet owner may be a dog owner or any other pet owner having one or more pets or animals to monitor. SW 113 is a dedicated thin client application that provides a vehicle for passing tracked pet activity data to a tracking and recommendation service for data processing and analysis. SW 113 is also a browser-based user interface (UI) for ordering pet foods and nutritional supplements and other products that are specially adapted for their pets.

Application 113 may be available on a non-transitory medium with an available motion tracking hardware device such as a motion tracking device 112a as a kit that may be purchased. Tracking device 112a is a data tracking device that may be attached to a pet such as a dog for example. A user operating smart phone 109 aided by SW 113 may have wireless data communications access to tracking device 112a. Tracking device 112a is an electronic activity tracker that functions to track movement of the dog or other pet. The tracking device may record steps (walking or running) distance traveled, total time tracked, and other motion-based activities in some embodiments.

Tracking device 112a may be in the physical form of a device attached or otherwise integrated with a dog collar 201 that may be worn by a dog, for example. Tracking device 112a may, in some embodiments, be modified to clip on any apparel worn by a dog such as a vest or saddle bag, as a leg band, or some other wearable item based on the availability of accessory parts. Tracking device 112a is adapted in this embodiment with a means for wireless communication over a network. More specifically, as a Bluetooth™ enabled tracking device that may be paired to client-operated smart phone 109 which, is also Bluetooth™ enabled for short range wireless communication.

In one embodiment, the means for communication between phone 109 and tracking device 112a is Bluetooth Low Energy™ (BLE). In one embodiment, tracking device 112a may include a subscriber identity module (SIM), a subscriber identity module or subscriber identification module (SIM), widely known as a SIM card, is an integrated circuit that is intended to securely store the international mobile subscriber identity (IMSI) number and its related key, which are used to identify and authenticate subscribers on mobile telephony etc. . . . . A SIM enables the tracking device to bypass near to far wireless communications means. In still another embodiment tracking device 112a may use wireless fidelity (WiFi) to communicate recorded data over the network. Tracking device 112a may optionally include a data display and may send data, receive data, and display data.

Another device that may be provided to a pet owner operating smart phone 109 is an electronic dog bowl 112b. Bowl 112b is a tracking device adapted to track consumption of food in the bowl or water in the bowl. Bowl 112b may communicate with smart phone 109 using BLE. Bluetooth™ Low Energy is different from Bluetooth™ only in that BLE has a low power sleep state that wakes up when the device beacon is recognized by the smart phone running application 113. Bowl 112b is adapted by digital weigh scale technology to track the amount of food or water (volume) consumed over time. In one embodiment bowl 112b is a dedicated food bowl or a dedicated water bowl. In that case a pet owner may obtain a smart dog food bowl and a smart dog water bowl. Bowl 112b may send data wirelessly. More detail about Bowl 112b (electronic bowl) is provided later in this specification.

A Pet owner operating smart phone 109 aided by SW 113 may also have access to one or more other electronic devices like an electronic weight scale (not illustrated). In one embodiment, a pet owner operating smart phone 109 aided by application 113 may have access to one of, or a combination of available devices. In a general embodiment, the pet owner needs at least tracking device 112a for activity tracking and may optionally add another device like bowl 112a, and or the pet scale. Each device produces its own unique device-specific data and general data of interest to the pet owner. It is desired that more than one device may be used in combination to produce unique data sets that may be uploaded over Internet 101 to a data processing and client fulfillment and to recommendation service such as in a working domain referenced herein as working domain 102.

Working domain 102 represents the back-end part of the pet tracking and fulfillment service in one embodiment. Working domain 102 may be a set of reserved cloud servers and repositories and data processing tools (SW) that are strategically adapted to provide a stable base history of the activity and wellness state of a pet including making recommendations to the pet owner. Recommendation may include the opportunity to purchase food and supplements for their pets over the network. Pets being monitored in the system may have very different nutritional needs based on different breeds, age of breed, and medical condition of the animal. Therefore, the service of the invention includes a line of nutritional food products that may be mixed or formulated to obtain optimum nutritional maintenance for specific breeds. Moreover, formulas such as bone broth formulas, or broth formulas fortified by vitamins and minerals may be altered or custom mixed for pets based on breed, gender, age, and wellness state (relative to standard) wherein the data results have already been calculated at least once from tracked data in light of knowledge data and third-party held data, and documented in owner/pet labs 119 (data space reserved) for a pet and pet owner. Owner/pet labs 119 is navigable via application 113 on smart phone 109.

Working domain 102 includes a local area network (LAN) 103 having connection to Internet 101 through a data network hub 108 such as with an Ethernet network for example. LAN 103 supports a data processing server 106 labeled a pet tracking server (PTS). Pet tracking server 106 hosts a SW application 122 adapted to receive tracked data, normalize that data for processing (if required), and processing the received data to data results that may be maintained in a server-connected data repository 120 adapted to contain owner information and pet wellness data formatted as pet labs data. Pet labs data may include but shall not be limited to the pet's latest physical wellness state, the current amounts of food/nutrition and water the pet is consuming on a regular basis, the statistics (base state) of the pet relative to nutritional health, hydration, and the statistics relative to a pet's weight, body mass index (BMI) etc.

Data calculated and stored in archive for an owner/pet may include goal-oriented data wherein a goal data set may be presented against a current data set (real data) for any of the categories of data available for viewing. The tracking service cooperates with a recommendation service, referenced herein as recommendation SW 123 hosted on a recommendation server 107. Such cooperation may result in improvements in the pet's nutritional and hydrological intake and in the recommendations of certain activities to the owner to help optimize owner pursuit of one or more stated goals for a specific pet relative to health and fitness state of the pet.

Pet tracking server 106 may receive data from an owner such as one operating smart phone 109, for example. In one embodiment, information server 105 and website 116 (web service) function as a proxy server and may broker the connection between cloud-based services and the smart phone device 109. Device 109 running SW 113 may access any activity data from tracking device 112a over an established Bluetooth BLE™ (BLE) connection requiring device/phone paring and network node discovery, a WiFi connection, or a SIM connection. In one embodiment, tracking device 112a may automatically send all its tracking data whenever the wireless connection is active between the tracking device and smart phone 109. Tracked data may include motion data including steps or strides taken, direction of or route of travel (GPS), heart rate, respiratory rate, blood pressure rate, local ambient temperature, and exposure levels to ultraviolet radiation (UV). In one embodiment, the tracking device is in sleep mode and wakes up once recognized by the smart phone saving energy. In one embodiment, tracking device 112a may be manually powered on and off as required.

Application 113 may also receive data from any other device the owner is using as they are all wirelessly enabled for communication. Pet bowl 112b may provide hydration rate over a tracked period of time such as number of ounces of water a pet has consumed up to a reporting period. A pet owner may receive updates or notifications relative to the smart bowl that may appear (displayed) in application 113 on phone 109 informing a pet owner of times during an activity where it may be appropriate to hydrate a tracked pet wherein the notification may also recommend an amount to put in the bowl. It is noted herein that a pet owner operating smart phone 109 may practice the invention with only the tracking device 112a and the client application 113 without departing from the spirit and scope of the invention. It is also clear to one with skill in the art that the client may use all the illustrated and described devices or any combination thereof without departing from the spirit and scope of the invention. In one embodiment of the present invention, all the pet tracker recorded data is uploaded to the smart phone 109 through application 113. Data aggregated from the sum of tracking devices used if more than one may be uploaded to PTS 106 running SW 122. The data may be received on behalf of a pet owner/subscriber and normalized for data processing. Normalizing data may mean recalculating for uniform metrics, averaging or rounding figures, sorting according to a data model or according to some priority, formatting data received from a third party tracking device, and the like.

In one embodiment, SW 122 may access third-party data from one or more local or regional information sources such as a weather service, for example, to get Geo-specific temperature data, Geo-specific weather predictions, humidity levels, pollen levels, and particulate levels, that may influence the experience of and or comfort of a pet being tracked. A third-party server (TPS) 104 is depicted supported by Internet 101 and connected to a data repository 118 adapted to contain third party data. TPS hosts an application program interface (API) 114. API 114 may be an API for SW 123 on recommendation server 107 for seamless acquisition of requested third party data.

In one embodiment, discovery of third party information is governed by rule or constraint. For example, if a pet owner determines to walk a pet on a specific route having a known length at a specific time and date, the system may aid the pet owner by planning hydration and nutrition for the pet during the walk (if required). The system may access third party data anytime before the event to determine the predicted climate during the planned activity and may use that data in forming any recommendations sent to the pet owner.

Hot temperature along the route may cause more water loss in a pet than normal leading to a special recommendation for additional hydration and maybe a protein dog snack listed in the user's account as a product the owner may have access to. In this case, the protein dog snack may be part of a wellness recommendation for a dog with arthritis wherein the product contains glucosamine and turmeric known to help reduce inflammation. Such a product may be subject to a transaction made by the pet owner through the client application, the transaction based on a recommendation made to the pet owner after processing data about the pet. The processed data may be saved on behalf of the owner/pet in repository 120 containing resulting (post processing) owner/pet labs data. Data held in repository 120 may be accessed during processing of new data to determine by comparison or relativity weather new data might lend to a recommendation or a notification.

SW 123 outputs the resulting processed data to recommendation server 107 running recommendation SW 123. Recommendation SW 123 is adapted to read results received and determine, with additional calculation if necessary, whether any recommendations or special insights or other notifications should be ordered for a pet owner because of a noted shift or deviation of certain data from normal in pet labs or from system recognition of data relative to ordering product such as a notification to re-order a supply of mineral bone broth, or a recommendation to switch from one protein type to another protein type. A base normal for an active pet may be established relatively early through repetitive tracking and adjustment of calculated results.

Recommendation engine 123 may create general notifications for encouragement, congratulations on goal achievements, tips or advice relative to any data. In one embodiment, SW 123 may participate in chat conversations with a pet owner through application 113 using artificial intelligence (AI), optical recognition for images and text, and interactive voice recognition capabilities (IVR). Such conversations may be adapted to service the client such as setting up a planned activity with the pet and estimating benefit for the pet, or simply logging nutrition consumption data reported by the owner into that pet's user labs. In one embodiment, AI interaction services include AI coaching for goal-oriented pet owners who subscribe to it. For example, a pet owner that has a working herding dog in training with a goal of conditioning the pet to handle a large herd of cattle may utilize an AI coach to help with advice, recommendations, and the accompanying logic or information validating the advice.

An AI coach may assist the pet owner in helping create future activities for their pets (through recommendation) that will be most relative to attaining the owner's goals for their pets. Attributes of an activity such as walking or running may include but are certainly not limited to the average rate of speed of the owner/pet during the activity, the length of the route taken by the owner/pet, the ambient temperature at the route, and the grade or slope of the route up or down (if not flat) or both up and down if hilly. In one embodiment, the system may be able to predict traffic on an activity route at a certain time based on third party data, such as registration information for a group activity like a group dog walk. If a route has third party cameras, the system may be able to access those feeds (cams) and make real time calculations about traffic on a route ahead of a pet/owner traveling the route. The owner may receive a notification about auto or human traffic further up on the route or if a rout is detoured or blocked, etc. An AI coach platform operated through application 113 by the user may scan in bar codes, recognize certain images and text, and provide supportive information to the owner such as a digital map of a route the owner plans to hike or run with their pets.

Recommendation server 107 aided by recommendation engine 123 may access a base of previously compiled knowledge in data repository 121. Experts in veterinary science contribute to and may provide updates to information held in data repository 121. Data within repository 121 may include results and methods of clinical trials or published studies and knowledge data resulting of clinical study along with general knowledge data surrounding pet nutrition where it applies to general states or goal-oriented progress states of a pet. Furthermore, the knowledge in repository 121 may include knowledge data about standard specifications relative to equipment and or accessories that may be used during an activity with a pet. In one embodiment, a pet owner may report specification data about a piece of equipment or implement the pet/owner may leverage during a tracked activity with their pets. More data about incorporating equipment specification into user lab data processing will be provided later in this specification.

Recommendations may include product order recommendations designed to provide optimum nutritional health of the pet in alignment with any goals the owner has for their tracked pet. The AI coach or adviser may validate an owner's goal for their pet or may inform or recommend to the owner that their stated goal is not achievable in whole or in part, for example, within an owner referenced time frame for achieving said goal for their pet. The AI coach may then produce an alternative goal for the owner's pet that may be more logically achievable within the owner's stated time frame without disconcerting the owner or dissuading the owner from attempting to achieve progress in the wellness of their pet.

Nutritional requirements may change over the course of goal attainment and after attainment of a goal. The system of the present invention considers mitigating factors described above and adjusts the content of recommendations directed to the owner. The system of the invention tracks proteins fats (animal/vegetable) and carbohydrates (PFCs) including micro-nutrients (vitamins, minerals etc.) and relates to each pet owner on a personal basis in recommending the above products for pet consumption, wherein those recommended products are integral to attainment of that owner's specific goal or goals for their tracked pet. The system may track exposure to sun and calculate vitamin D requirements and how much vitamin D is revealed from foods eaten to determine whether a pet may be deficient and needs more vitamin D. The client application may automatically input the exposure data and calculate from reported food consumption data information to figure out if your pet is receiving the proper amount of vitamin recommended by veterinary professionals.

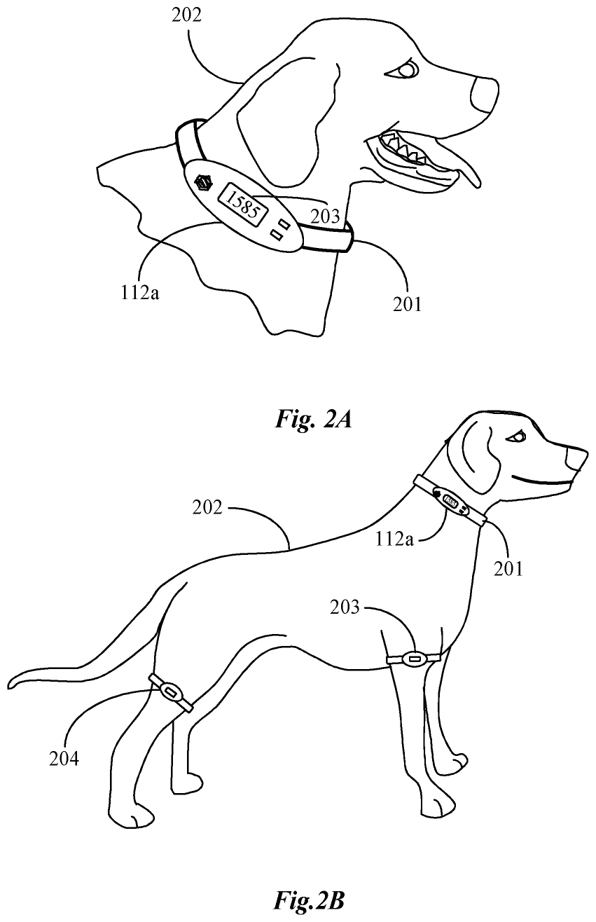

FIG. 2a is a profile view of the motion tracking device 112a of FIG. 1 mounted to a collar 201 on a dog. Tracking device 112a may be attached to an adjustable dog collar 201 using loops to thread the collar through, clips to clip onto the dog collar, or other attachment means to fix the tracking device to the collar 201. In one embodiment, tracking device 112a is a collar 201 with the tracking device housing material contiguous with the collar material portion of the device. Tracking device 112a, in this embodiment, is an electronic hardware module having a touch screen display

Tracking device 112a comprises a hardware electronic device that may or may not include an information display or a touch screen display. Screen display 203 may be a liquid crystal display (LCD) that may be a monochrome display (black and white). Other types of touch screen displays may be provided without departing from the spirit and scope of the present invention such as an organic light emitting diode (OLED) display for example. Display 203 may be a resistive display or a capacitive display. In an alternate embodiment of the invention, tracking device 112a has no digital display capability and all of the notification, recommendations, and result data are accessed by the owner using a smart phone and running the client application. One reason for providing a display or at minimum LED indicia directly on the tracking device is enabling an owner to witness a flash or light on the device that may be an important notification about the tracked pet. However, all such data may simply be redistributed to the owner from the owner/pet labs by pushing the data to the phone application on the owner's phone or by providing notification to the owner's phone informing the owner of the new data and a link to access that new data.

Tracking device 112a includes a company logo graphic applied on the outside surface of the tracking device housing. The company logo may be a physical touch point for powering the tracker on or off. In this example, screen 203 is displaying the number of steps (1585) tracked by the device over a period of time. If tracking device 112a includes display screen 203, a logo may be placed on the screen and may be a trigger for scrolling through data that might be available on the screen, continued tapping of the company logo scrolls through data points that may be displayed on screen 203. However since a pet cannot view or interact with the screen 203 a display screen is unnecessary. All data may be accessed through the lite application running on the owner's phone.

It is noted herein that tracking device 112a may be removed from the pet collar 201 and placed onto some other apparel that might be worn by the pet. In a preferred embodiment, tracking module 112a is a water proofed device that may withstand submersion in water, for example, swimming with it. In one embodiment, pet tracking device 112a remains in a sleep mode until it is moved whereby a motion sensor that may be provided within the device picks up the motion and wakes or boots the device. In another embodiment, a tap on the screen logo in the corner of screen 203 wakes the device for both active data tracking and Bluetooth™ or other wireless communication means with the pet owner's smart phone running application 113. Other data points that might be displayed may be date and time, time of tracking in minutes, seconds, or other intervals, distance traveled in feet, miles, or other measures, calories burned, and ounces of liquid consumed (hydration).

Tracking device 112a may be a device with a plastic molded housing that includes one or more compartments adapted to house the circuitry and sensors provided and used in the tracking device. In one embodiment, tracking device 112a includes a rechargeable lithium ion battery (long life) battery. In one embodiment, a USB charge cradle (not pictured) may be provided that can enable the device to be removed from the pet collar 201 and then plugged into a computer USB port to recharge batteries of the device. It may be noted herein that empirical tests note an average long battery life of four weeks or so.

FIG. 2b is a side elevation view of a dog wearing motion tracker device 112a of FIG. 2A in communication with one or more additional devices according to an embodiment of the present invention. In one embodiment of the present invention, pet tracking device 112a may communicate with one or more peripheral electronic sensor devices whereby the pet tracker device is a parent device and the peripheral devices are child devices. In this embodiment, a peripheral sensor device 204 and a peripheral sensor device 205 are provided as child devices to pet tracking device 112a.

Pet tracking device 112a may track time and distance walking or running and the owner's GPS data (phone/app) may provide location data. Number of steps may be calculated based on logged or archived information about the pet being tracked and the distance over time data provided by the tracking device. Peripheral devices 204 and 205 may be identical sensor devices that track motion over time and include orientation. Motion sensor 204 may record forward motion, acceleration, and distance of the dog's rear leg motion, while motion sensor 205 may record the forward motion, acceleration, and distance of the dog's front leg motion. In actual practice motion sensor 205 may be worn on the dog's opposite front leg from what is depicted or the left front leg to include motion from the other side of center (dog) in analysis.

In this example, tracking device 112a polls devices 204 and 205 over a wireless communication link for recorded motion data for a rear leg and a front leg. In this way a gait analysis of dog 202 may be performed to determine stride walking or running, and balance of gait such as weather dog 202 is favoring one side or another in gait. In one embodiment, peripheral devices 204 and 205 may be accelerometers. In another embodiment an accelerometer and gyroscope sensor are combined in one peripheral tracking device such as device 204 or device 205.

It is noted herein that in this embodiment, all data tracked by peripheral devices may be sent to the parent tracking device 112a and then offloaded to the owner's phone application. In another embodiment, the collar 201 based pet tracking device 112a, and peripheral motion tracking devices 204 and 205 all communicate their data directly to the owner's phone whereby the owner forwards the data to the web service for processing. One benefit to having a means to track a pet's gait is that gait abnormalities may be spotted in the processed data and flagged if repetitive. The detection of an abnormality may be equated to a possible cause or condition and notification of the discovery and recommendation of how to investigate it further can be generated and sent to the pet owner in near real time.

Pet tracking device 112a may be used successfully without gait motion sensors without departing from the spirit and scope of the present invention. The parameters of gait may be inferred by estimate having system accessible knowledge of the physical attributes of the dog and the data provided by an accelerometer and perhaps a gyroscope provided in tracking device 112a. In other embodiments, sensors in tracking device 112a may be provided for tracking other data types and may include a barometer, a temperature sensor, an ambient light sensor, a heart rate sensor, a respiratory rate sensor, and so on. Some data a sensor might provide such as temperature data, elevation data, humidity levels, etc. may instead be acquired from a third-party data source such as a local weather service connected to the network. In one embodiment, such data might be provided through another application installed on the owner's phone that is tied to application 113 of FIG. 1 through an API.

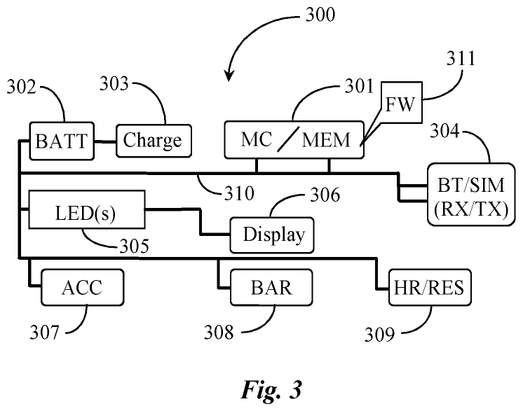

FIG. 3 is a block diagram depicting general electronic components 300 of tracking device 112a of FIG. 1. Components 300 may include but are not limited to a micro-controller and memory package 301 connected to an electronic bus structure 310 and powered by a rechargeable battery 302 supported by a charging port 303. An executable firmware (FW) 311 may be provided in memory that controls all of the functions and states of the tracking device. A wireless communications port 304 (RX/TX) may include Blue tooth components, WiFi components, or SIM components enabling communications between the device and the owner's phone. Port 304 may use any wireless protocol that exists at the time of this writing.

In one embodiment components 300 include a display screen 306 supported by a set of light emitting diodes (LED's) 305. Components 300 include an accelerometer (ACC) 307 adapted to sense motion and acceleration over time. Components 300 may include a barometer 308 adapted to provide elevation data, and optional heart rate (HR) and respiratory (RES) sensor 309.

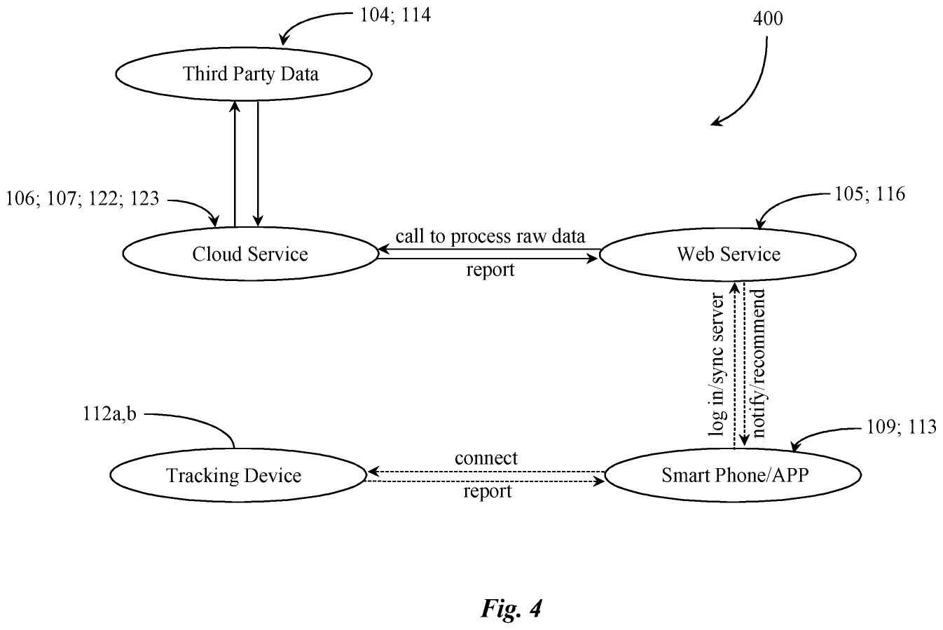

FIG. 4 is an abstracted architectural overview of a network hierarchy 400 of hosted parties and end network end points involved in the pet tracking and fulfillment service. A pet owner operating smart phone 109 with the aid of application 113 may connect with a tracking device such as tracking device 112a or 112b by detecting the device within range of the wireless network, for example Bluetooth™. It may be assumed that a tracking device is powered on and tracking data and caching such data for transfer to the smart phone 109. Tracking device 112a or 112b may report or pass data to smart phone 109 once a connection is established.

Smart phone 109 aided by application 113 may communicate with any in-range tracking device using a wireless network capacity in an off line state or otherwise not having connection to the service of the invention. A pet owner may log in to a web service 103 facilitated by website 116 and sync with the server. A pet owner may log in through application 113 and may be required to authenticate with the server to complete log in requirements. Once logged into the site the data for send on the pet owner's phone may be sent to web service 105 aided by WS 116. Data may be normalized for processing on the phone with the aid of application 113. Any new data arriving to web service 105 aided by WS 116 since the last owner log-in may be accessed from (viewed) or passed down to the owner's smart phone 109 aided by SW 113 as a data sync. Recommendations messages and notifications to the pet owner may also be sent to the pet owner's phone once logged in to the web service.

Web service 105 may call the cloud service referenced in FIG. 1 by elements 106, 107, 122, and 123 to process new data received from a pet owner. The cloud service analogous to services 102 of FIG. 1 may access data from a third-party data source analogous to elements 104 and 114 of FIG. 1. Third party data may be useful in processing pet data received or accessed. In one embodiment, cloud services may access any first party data not held in the cloud during processing of data. Calculated data results including recommendations and notifications are reported back to the web service for owner access. Data sent to the web service from the cloud may include articles, advertisements, veterinary resources, purchase confirmations, shipping confirmations, and like transactional information.

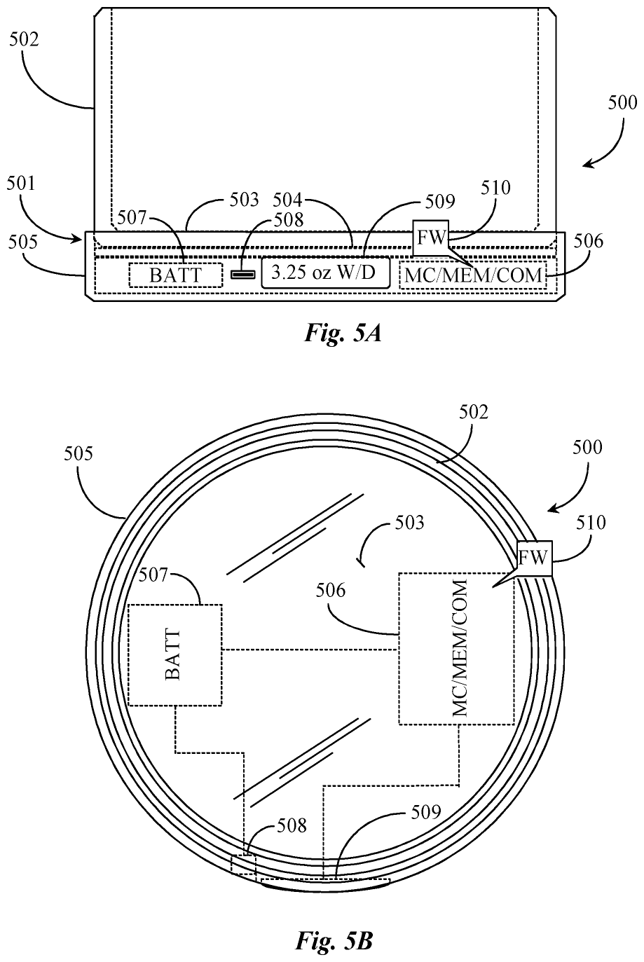

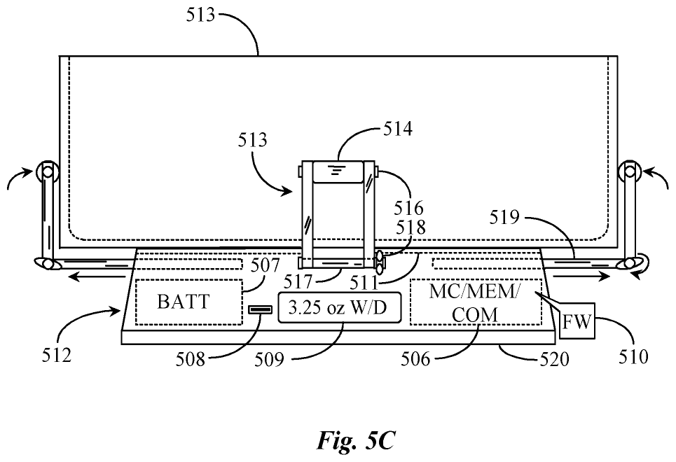

FIG. 5A is a side elevation view of a bowl scale device 500 analogous to bowl scale device 112b of FIG. 1. Bowl scale device 500 may be referred to herein as a digital smart bowl adapted with electronics as a tracking device for tracking and reporting the amount of food and water that may be consumed by a pet. In actual practice, an owner may have two smart bowls 500 for a tracked pet, one for water/broth and one for dry/wet food. Smart bowl 500 may include a bowl 502 having an open end and a closed bottom 503. Bowl 502 may be molded from plastic or may be provided in a stainless steel version. Bowl 502 fits into an electronic scale device 501 functioning as a base weigh scale that measures the weight of food or water placed in the bowl and tracks consumption of food or water out of the bowl.

Base scale device 501 may be an annular device having a housing 505 that may be plastic molded from a durable polymer material. Base scale device 501 has a lip formed around the device at top having an inside diameter just larger than the outside diameter of smart bowl 502 to effect a relatively frictionless fit between bowl and scale. An owner may remove the bowl from the base scale and place it back onto the scale whereby the lip keeps the bowl centered on the scale surface. The lip may extend sufficiently past the bottom of the bowl 503 to prevent tip over of the bowl. Base scale device 501 may include one or more weight plates (not illustrated) to provide additional security against accidental tip over of the bowl.

Base scale 501 includes a rechargeable battery (BATT) 507 and has a charge port 508 for universal serial bus (USB) or other electronic charge devices. Base scale 501 may be charged without the bowl. Base scale 501 includes a compartment 506 containing a micro-controller (MC) memory (MEM) and a communications module (COM). Base scale 501 may report data wirelessly to an owner's smart phone such as phone 109 aided by application 113 of FIG. 1. Wireless communication may be through Bluetooth™, WiFi, or a wireless carrier network. A long life battery enables smart bowl 500 to be powered on and track and store data until such time to report the data to the owner's smart phone.

Base scale 501 is a digital scale that includes a scale surface 504 that makes contact with the bottom of bowl 502. Base scale 501 weighs bowl 502 empty and logs that data. When bowl 502 is filled with dry food for example, base scale 501 weighs the bowl and food and calculates the food weight be subtracting the bowl weight. A separate base scale may be used with a water bowl and operates in the same manner of weighing the total and subtracting the bowl weight from the figure. Base scale memory includes executable firmware (FW) 510 containing the operational instructions and routines for periodic weighing, calculation if required, and reporting weight of wet/dry food and water/broth. Optionally, smart bowl 500 includes a data display 509 for displaying total ounces consumed. However, a display is not required on the device because the owner may access that data on the smart phone with the aid of the tracking application.

FIG. 5B is a top view of bowl scale device 500 of FIG. 5A. Bowl 502 slips down into the base device housing 505 concentrically inside the lip feature. Charge port 508 and display 509 may be embedded partially within base scale housing 505. In one embodiment, there is no display and data is accessed from the smart bowl by the owner over a wireless connection. In another embodiment a display is provided enabling the owner to determine amounts including total amounts contained and total amounts consumed over time. In one embodiment, the micro-controller package in compartment 506 may control a set of motion detection sensors (not illustrated) that may be disposed on the base scale device and may boot the device upon trigger by an approaching pet.

In one embodiment, bowl 502 may include electronics that may derive power from battery 507 and contact means to transfer power from the scale device to the bowl such as electrical power contact pads disposed on the surface of the scale plate 504 and the bottom surface of the bowl. An owner may align the contact pads when inserting bowl 502 onto base scale device 501. In such an embodiment, motion sensors may be mounted around the outside bowl 501 so when a pet approached the bowl may wake up and begin tracking data.

In one embodiment where the bowl is an electronic device deriving power from contact with the base device, food allergy sensors (not illustrated) may be provided and mounted on the inside of the bowl to come in contact with food in the bowl and may send a signal if a food contains by products a pet may be allergic to. The most common allergens include beef, chicken, fish, pork, lamb, rabbit, wheat, dairy, egg, and soy. Electronic sensor that scan food for allergens and send the data to a cell phone are being developed for allergens like gluten and milk for humans. Such sensors may be modified and adapted to detect common pet allergens and foods toxic to pets.

Smart bowl 502 and base scale device 501 can be provided in diameter and bowl volume that may be sufficient for large dogs, for example, a larger one for working dogs, a smaller one for medium size dogs, and a smaller one for toy dogs. A pet owner may connect with a smart bowl from their smart phone aided by application and collect food and water consumption data for application to owner/pet labs. In one variation of this embodiment, food and water consumption data is sent to the cloud service for processing along with other data and the cloud service updates owner/pet labs with the new data and provides any notifications or recommendations back to the owner through the client application. If the consumption data does not require processing, the owner may simply sync data with owner/pet labs to refresh the data held in archive. FW 510 contains the operational instructions for the functions of the device and the algorithms to calculate the correct amounts of consumed volumes over time.

FIG. 5C is a side view of a scale device 512 functioning as a bowl scale device according to an alternate embodiment of the present invention. In this embodiment, a smart bowl/scale combination comprises a base scale device 512 and a stock bowl 513. Stock bowl 513 may be any bowl of a suitable size (diameter, depth) to feed a pet from. In this embodiment base scale 512 is not adapted to ring the bottom edge of the bowl to center it and prevent it from tipping over. Scale device 512 has no lip rising above the scale weigh plate 511, which is the top surface of the scale device. Therefore, the bowl 513 may be larger or smaller in diameter than the base scale device 512. Base scale device 512 includes three or four articulating stop bars 513 that may be used to prevent a bowl from being moved laterally off of the scale surface 511.

Stop bars 513 include a rubber or plastic cylindrical stop 514 that makes contact with the surface of the bowl 513. Stop cylinder 515 is pinned between a pair of arm bars at the interfacing end of the apparatus. Stop cylinder 514 is annular and may be fabricated of a soft rubber material for a more stable interface. The opposite end of the pair of arm bars are hinged at the end of a rectangular track plate 519 extending into the housing of base scale device 512. Tightening nuts 518 are provided for tightening the arm bar apparatus or loosening the arm bar apparatus at the hinge point 517.

In one embodiment, track plates 519 may be mechanically recessed into the housing of base scale device up to hinge pin 517. The arm bar may be loosened with the apparatus loose the arm bars may be lowered by rotating them back and down. The track plates may be extended out from the track base and locked at any desired position to accommodate a bowl that is a larger diameter than the base scale device. A pet owner may put a large diameter bowl substantially centered over the base scale device and then pull out each track plate, rotate arm bars in the direction of the arrows depicted until stop cylinders 514 make contact with the edge of the bowl. The arm bars 513 may be tightened in position to keep the bowl 513 centered and prevent tip over.

Base scale 512 may include a weighted base plate 520 to enable more stability and less probability of tip over. The electronic components battery 507, display 509 charge port 508 and micro-controller package 506 as well as FW 510 may be identical in both versions of the base scale device. A pet owner may put a volume of food or water in a smart pet bowl and turn the device on for feeding/watering of the pet. The owner may return later and make a wireless connection with the base scale device. Once connected, the device will offload data to the owner's smart phone specific to the amount of food or liquids consumed over the elapsing time period. In one embodiment the smart bowl goes into sleep mode if no activity (eating/drinking) is detected.

In one embodiment, the action of eating or drinking provides enough motion evidence for the bowl to boot and weigh the current volume of food or liquid. In wake mode, the circuit may weigh volume in small intervals of time as a pet is consuming food or water in a session. If the pet is consuming intermittently, the smart bowl may adjust itself to weigh at longer time intervals or drop back into sleep mode after a reasonable time period where no motion is sensed.

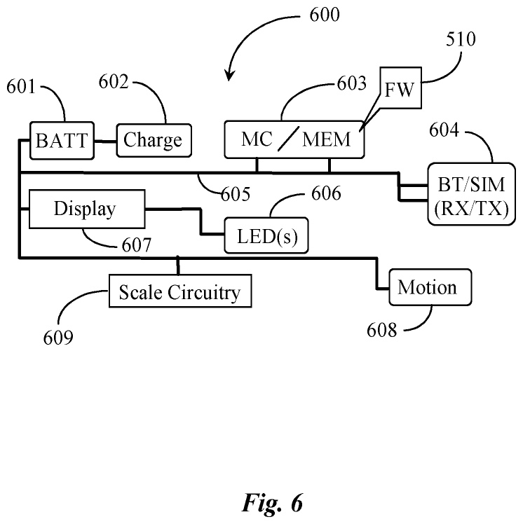

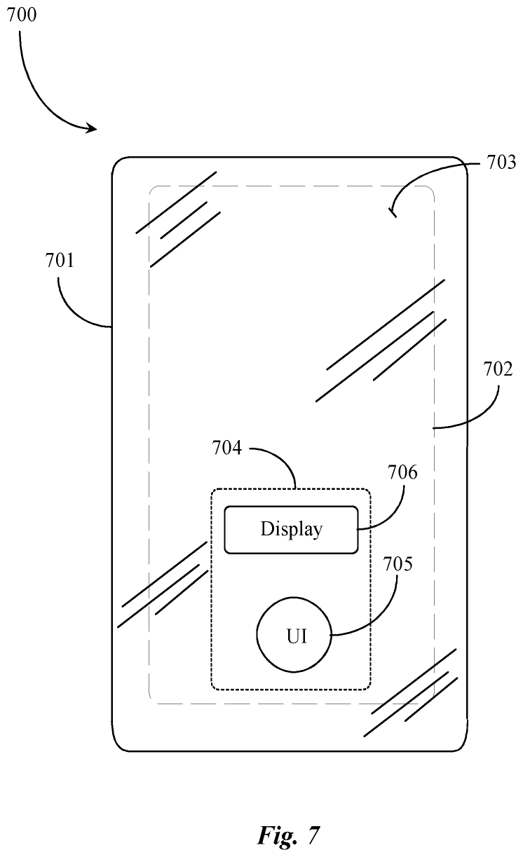

FIG. 6 is a block diagram depicting electronic components 600 of the bowl scale device of FIG. 5B or of 5C. Components 600 include a rechargeable battery 601 and a charge port 602 analogous to battery 507 and charge port 508. A logical power and communications bus structure 605 is depicted bridging the components for power and communication. A micro-controller with memory 603 is provided hosting FW 510. Communications module 604 is provided for communication with other devices. Module 603 and module 604 are analogous to the components in compartment 506 of FIGS. 5A-C though they are mounted separately but connected by the bus structure in this embodiment.

Components 600 further include a display circuitry 607 supported by one or more LED circuits 606. It is noted herein that a display and associated lighting is optional and not required to practice the invention as data calculated by the scale device may be displayed on a second device such as the pet owner's smart phone aided by the client application. Digital scale circuitry 609 is provided to support the scale surface of the device, which may also include mechanical components common to a digital scale. Components 600 may include one or more motion sensors 608 adapted to detect motion caused by a pet eating or drinking causing the device to wake from sleep mode.

A user putting food or liquid in the bowl prior to a scheduled feeding of the pet may cause the base scale device to wake and begin measuring. In one embodiment, the smart bowl device may remain awake until a specific time period set by the owner elapses where no activity is detected. The device may return to sleep mode saving battery life until the one or motion sensors detects new activity. In another embodiment, the smart bowl device is manually powered on after the pet owner fills the bowl with food or water just before a scheduled feeding and the pet owner may return at some later time to connect with the device and access the data recorded since it was powered on. In one embodiment, once the pet owner has received data from the base scale device the device is cleared of the data until a next feeding time. A feeding time may be relatively short for a healthy pet eating a prescribed amount of food. In this way the pet is not overfed because the feeding times and amounts are calculated parameters.

FIG. 7 is an overhead view of a biometric digital animal weigh scale 700 according to an embodiment of the present invention. Weigh scale 700 is not introduced as a tracking device in FIG. 1 because it is an optional device that pet owners concerned with managing the weight of their pets may purchase as part of the Zenimal™ (trade name) package. Weigh scale 700 is a biometric enabled smart scale that can, through biometric sensor array, record total weight, body mass index (BMI), bone density, detect total water weight, total bone mass, and can discern lean body weight from overall weight including fat weight. Weigh scale 700 may be enabled for wireless communication such as Bluetooth™, and can communicate over a Bluetooth™ network with a pet owner operating smart phone 109 of FIG. 1. Scale 700 may also be enabled to access WiFi network and or a wireless carrier network (telephony) in some embodiments.

Weigh scale 700 includes a scale housing 701, a bio electric scale surface 703, and a general step boundary area 702, within which a pet such as a dog should stand. Pet weigh scale 700 is rectangular and elongated to accommodate the body length of a pet on all four legs. Scale 700 may be manufactured from a durable polymer and may be covered on the scale top surface with tempered glass material 703. There may be more than one size of scale 700 available. Using a dog as an example, scale 700 may come in a size for toy dogs, a larger size for medium size dogs, and a larger size for larger dogs. Weigh scale 700 include a user interface (UI) 705 embedded in the weigh scale surface 703. A pet owner may manipulate UI 705 by touch to navigate through various settings including calibration, units of measure, and settings that activate or mute certain weigh calculation features like total water weight or BMI.

Weigh scale 700 includes a circuitry compartment 704 housing the electronics components of the weigh scale such as the micro-controller and communications module, display and supporting bio-electric circuits. A display 706 may be an LED or OLED display embedded in surface 703 and may be a navigable touch screen display allowing a pet owner to navigate through and see the different data results for different weigh settings. Weigh scale 700 may be described as a smart scale adapted to measure total body weight, total body fat, total muscle mass, total water content, total bone mass, bone density, and visceral (abdominal) body fat percentage to reveal lean muscle weight. In one embodiment settings for all of the different weight categories with the exception of total body weight may be set to on or off by the pet owner through UI 705 and display 706 using touch screen methods.

Information recorded on pet weigh scale 700 may be communicated wirelessly to another connected device over wireless network. A pet owner may set up a schedule to weigh their tracked pet and report the data to the cloud service for processing and update to pet/owner's labs. Pet weigh scale 700 utilizes an embedded bio electrical impedance system for determining the subset data such as water content, bone density and mass and fat weight versus lean muscle weight measurements and the like. In one embodiment, bio-electric impedance analysis (BIA) is incorporated into the scale top surface 703 and supporting circuitry and FW to enable calculation of overall weight, total body water (TBW), lean fat-free mass, visceral fat, overall BMI, bone mass and density. In one embodiment, pet weigh scale 700 uses non-rechargeable alkaline batteries such as two AA batteries and does not include a charge port. In one embodiment, a manually operated toggle switch (not illustrated) may be provided to enable toggling between pounds and kilograms for example. However, in one embodiment the scale may use rechargeable batteries like the other devices.

Measurements taken by pet weigh scale 700 may be used as data input in data processing in the cloud service for generating recommendations and for making adjustments to wellness data and current supplement needs of the pet. If bone density is trending low for example, a supplement known to the system that enhances bone density may be recommended to the pet owner for purchase. For a pet owner with a goal of reducing the weight of their pet, a scheduled weigh in such as once weekly provides the data required to determine efficiency of current food and supplementation rates for the pet. The system may recommend additions or reductions in the amounts of food provided for the pet. The system may recommend adding or subtracting supplements or reducing or increasing supplements. Such recommendations may appear in the client application 113 running on the owner's smart phone 109 as a type of notification, as a text message, in an email, or in a synthesized voice mail.

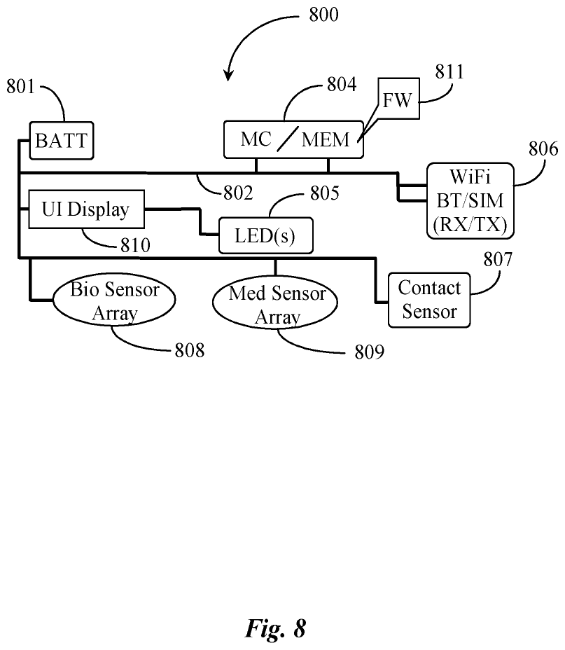

FIG. 8 is a block diagram depicting general electronics components 800 of the pet weigh scale 700 of FIG. 7. Pet weigh scale 700 of FIG. 7 in a preferred embodiment does not use a rechargeable battery and therefore requires no charging or charge port. A set of batteries (BATT) 801 is provided to power the unit. A logical bus structure 802 for power and communication is depicted bridging the components for power and communications. A micro-controller/memory (MC/MEM) module 804 is provided and the memory portion hosts a FW 811. FW 811 is executable on the device and contains all of the instructions and computational algorithms required to perform all of the device functions from boot up to archiving data for send to another device. All of the logic and routine instruction sets for performing bio-electric impedance analysis (BIA) are contained in FW 811.

A communications module 806 is provided for communicating data to another device such as the owner's smart phone 109 running application 113 of FIG. 1. In one embodiment, scale 700 of FIG. 7 records weight data and makes the data available for access from another device, but does not receive any data from another device. In one embodiment, components 800 include a USB comparable port for offloading data over a USB wire to a laptop or other computing device. In a variation of this embodiment, the USB component is wireless and can communicate the data to another USB wireless enabled device. In still another embodiment, some of the device memory may be on a portable SD card that can be removed and inserted in the owner's smart phone (109 FIG. 1) whereupon the running client application (113 FIG. 1) takes the data and forwards that data through the web service to the cloud service for processing, updating, and recommendation.

Components 800 include a user interface (UI) display module 810 and supporting LED (s) 805 for providing back light and status indications. In one embodiment, one or more contact sensors 807 may be provided embedded in the scale weighing surface to boot the device when a pet is placed on the scale. In one embodiment, the pet weigh scale 700 of FIG. 1 may be adapted to weigh total body weight in a sleep mode or power save mode wherein the biometric function and any other medical sensor functions are powered off or muted.

Components 800 include a bio sensor array 808 embedded in the step surface of the scale. In one embodiment, additional medical sensors may be provided as a surface array 809 for detecting pulse, body temperature, or other medical signs that may be detected bio-electrically through the paws of the pet. In one embodiment, the system processes weight data in light of information already known and supplied by the owner, for example a dog breed, original size (shoulder height, body length) and original and serially archived weight data sets. In addition the system may take into account current feed and supplement data, and hydration data already logged through past tracking.

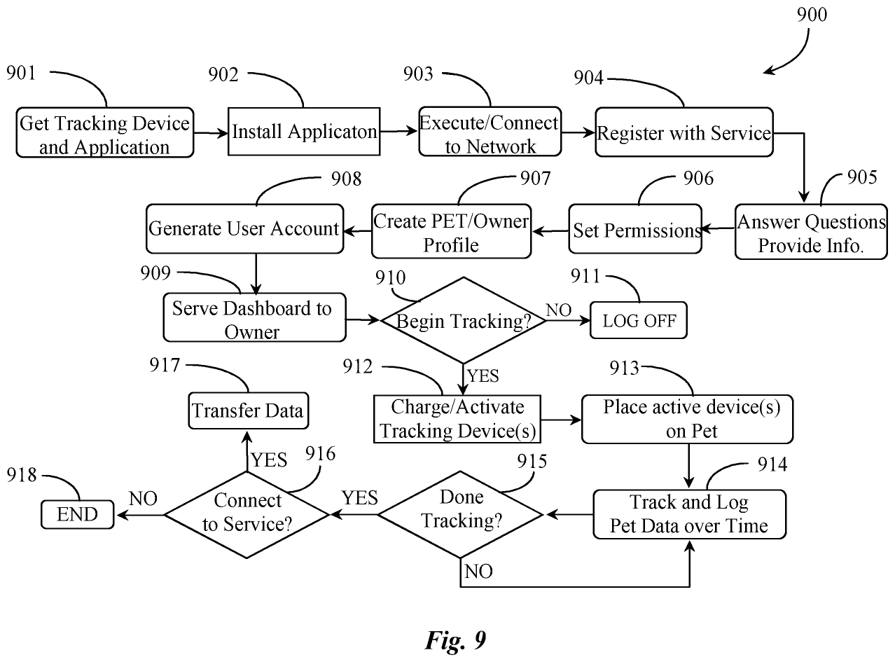

FIG. 9 is a process flow chart 900 depicting steps for setting up the service for tracking for the first time according to an embodiment of the invention. At step 901, a pet owner may obtain at least a Zenimal™ tracker (collar device) and a link to the web service for downloading a client application. A full kit may include additional wearable motion sensors like sensors 204 and 205 of FIG. 2B, at least one smart dog bowl (two for tracking liquid and food consumption), and a bio electric pet weigh scale. At step 902, the pet owner may download the client application from the web service (site) and install the application on the owner's mobile device (smart phone, etc.).

At step 903 the owner may execute the application and connect online through the application to the web service if not still connected via the provided web link to the application. At step 904 the pet owner may register with (subscribe) to the web service. The web service may provide questions and options through the client application to the owner at step 905 for answering and or selecting options. Exemplary questions may include pet type (dog, other), pet breed, pet age, pet veterinary information, pet name, and like data about the pet being tracked.

At step 906, the web service may ask to set permissions for service electronic access to one or more applications or capabilities intrinsic to the owner's smart phone including access to photos and videos the owner may take of the pet. For example, subsequent photos captured during special moments with the tracked pet may be organized by the web service having access to the photo repository on the owner's smart phone into a third-party template or publication form that the owner may review and post one or more third-party social media platforms. The client application may include one or more application program interfaces (APIs) to other programs installed on the owner's phone allowing the web service client application to utilize other programs through permission of the owner.

At step 907, the pet owner may create a pet/owner profile for visual and information display to other pet owners subscribed to the web service. In one embodiment, pet owners may socially interact with one another through the web service including home page view, messaging, video chat to share stories and accomplishments of their pets. A pet/owner profile may include a shared profile picture and information about the owner and tracked pet. At step 908, the pet owner may generate a user account including setting authentication parameters and supplying financial information in a secure portion of the web service. At step 909, the web service may populate the pet owner's mobile dashboard with all of the data categories expected and the owner may begin tracking their pet as a new subscriber.

At step 910, the pet owner may determine whether to begin tracking pet data for the first time. If at step 910, the pet owner decides not to track the registered pet, the pet owner may log off at step 911 pending no other tasks. If the pet owner decides to begin tracking at step 910, the tracking device(s) may be charged and activated at step 912. The pet owner places the active device(s) on pet. In one embodiment there is a single tracker worn about the collar 201. In another embodiment the tracker communicates with child devices comprising motion sensors worn on a front and back leg of the pet. In the latter case, gait analysis may be performed to see if there are repetitive signals in the gait data of a problem.

At step 914, the pet owner may track and log pet data over time such as on a hike, jog, or bike ride with a pet. A pet may be tracked while on a leash, moving in an owner-controlled manner such as along side of a ten speed bicycle on a bike path, or simply running and moving freely in a field, at a dog park, at the beach, etc. It is noted that the tracking device has memory to store tracking data so that the pet owner need not have phone contact with the tracker during a data tracking session and the pet need not be near to or next to the owner while being tracked. Conversely, a pet owner may track a pet while the owner's phone is connected to the pet tracking device over a wireless network and also connected with the online web service over a second wireless carrier network. In this embodiment, it is possible that tracking data may be processed with results returned in near real time while the owner is engaged with the pet. Often an owner may simply track and later get the data and report it for processing. If the owner is concerned about knowing a result before a tracking session is over than live tracking may be practiced. One benefit of live tracking with peripheral child sensors is that near real time monitoring of gait data may be performed, whereby results relative to any noticed imbalances, limps, injuries the pet can experience on a run for example may be quickly relayed to the pet owner running the client application.

At step 915, a pet owner may determine whether they are finished tracking their pet. If a pet owner is not done tracking at step 915, the process may resolve back to step 914 continued tracking. If the pet owner determines to stop tracking at step 915, the pet owner may decide whether to connect with the web service at step 916 with an intent to transfer data 917 for processing. A pet owner may connect to the web service at any time in the process and may also track while fully connected. If at step 916 the owner decides not to connect, then the process may end for that session at step 918.

At any time forward the owner may connect and transfer data. If the owner decides to connect at step 916, the owner may transfer the pet data from the tracking device to the phone and to the web service for processing at step 917. Whether an owner decides to track pet data while disconnected from the service or while connected to the service depends upon the goals and concerns of the owner relative to the wellness of their pet. The owner may track while the owner's phone has a wireless connection open to the tracking device and the tracking device offloads to the phone instead of logging. The owner may do this while not connected to the web service or while the owner is also connected to the web service. In this way, the owner has control over how quickly results are calculated and updated over the network to owner/pet labs. In the full connected mode, the owner may receive timely notification of any problem, for example, pet has just developed a gait imbalance favoring the left front paw maybe a thorn or piece of glass please check. Or it may be more vague where a notification saying gait anomalies detected recommending you pause and check your pet for any issues.

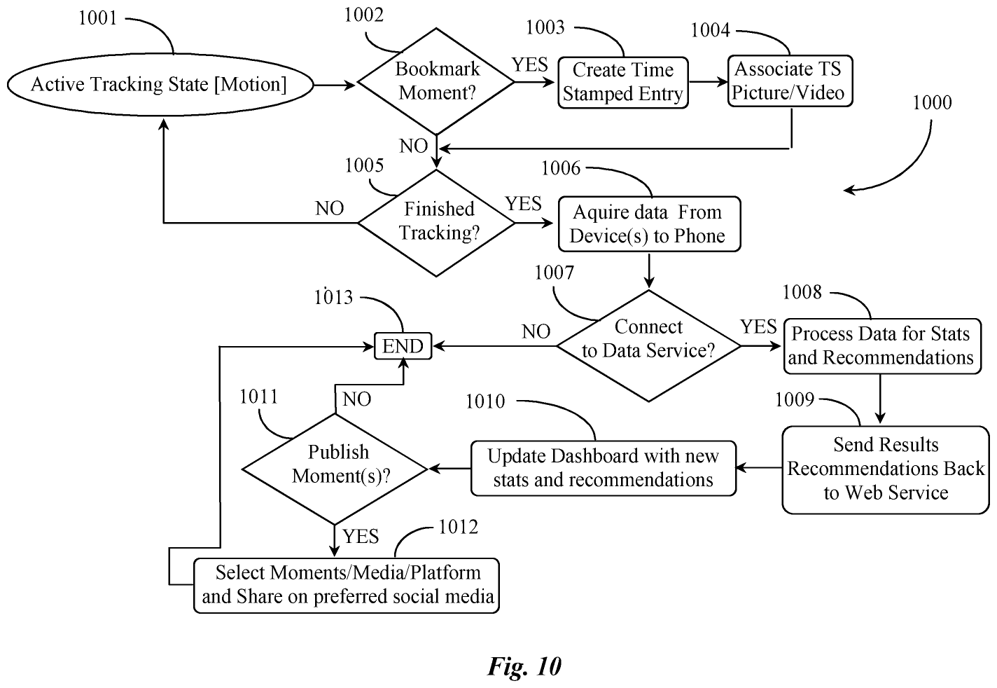

FIG. 10 is a process flow chart 1000 depicting steps for tracking motion, recording special moments for publishing, and receiving recommendations and or notifications based on data tracked and analyzed. It is assumed in this process that the pet owner is in a current and active tracking session with their pet at step 1001 and the wireless connection between the tracking device and the owner's phone is active with the client application running.

At step 1002, the owner has an opportunity to capture or book mark any special moment that the owner may determine anytime during a hike, or run, or walk with their pet. If the owner determines not to capture a moment during a session, he may determine at step 1005 whether to stop tracking. If at step 1005 the owner determines not to stop tracking the process resolves back to step 1001 continued tracking. If the owner determines to stop tracking at step 1005, the owner may acquire data from the device to phone at step 1006. This step may be an ongoing step in an embodiment where the wireless connection between the owner's phone and the device is on where the tracked data is offloaded directly to the phone and is not kept on the tracking device.

If at step 1002, the owner determines to bookmark a moment, the owner may, through the client application running on the phone, create a time stamp entry having date and time information and perhaps a session number. This time stamp entry represents any moment during the tracking session that the owner decides is worth capturing. At step 1003 and 1004, the owner may take one or more pictures of the moment or a video of the moment for documentation thereof, the media being the first media executed after the created time tamp.

Also at step 1004, the media files created and stored may be automatically associated with the moment time stamp until the owner stops creating media for a period indicating that the moment media for that moment has been created. The period may be set by the owner in one embodiment, for example 5 minutes, after which future files are not associated with the time stamp moment. The process may move to step 1005 where the owner may determine whether they are finished tracking. The moment entry created on the phone with the aid of the client application can be matched to the same moment in time in the tracked data stored on the device or already transferred to the phone. At step 1006, the owner may initiate a transfer of the tracking data to the phone if it has not been directly offloaded to the phone in real time.

At step 1007, the owner may determine to connect to the web service to process the data including attentions to the captured moment and associated media. If at step 1007, the owner does not wish to connect with the web service and is finished tracking data, the process may end for that session at step 1013. If the pet owner determines to connect to the web service or is already connected at step 1007, the owner may send the tracked data for processing and possible recommendations at step 1008. The cloud service responsible for data processing and update and recommendations may send processed data results and any recommendations back to the web service at step 1009. The web service may update pet/owner's labs after receiving new data from the cloud or it may be the cloud service that has access to pet owner's labs data. The owner/pet dashboard can also be updated in step 1010 with all the new data when the owner syncs data with the web service making the data available for view in the owner's client application.

At step 1011, the owner may have an opportunity to publish any moments captured during the pet tracking session. If the owner does not want to publish moments or did not create any to publish, the process may end at step 1013. If at step 1011, the owner decided to publish one or more moments, then at step 1012 the owner may select which moment (time stamp/media associated), media, and SM platform (facebook, Instagram, Zenimal) and may review a post and share the information online.

The client application may use APIs installed with the application to manipulate another application or application function otherwise performed manually by the owner. The moment is time stamped and associated with the correct media taken by the owner. The application collects the moment media and formats it for share in post, for example, on the SM platform. The media is auto attached and the owner may see and add captions and text before selecting post to publish the media. In one embodiment the moments may be serially collected and published in a story board of a picture story site platform, or in any other template driven platform. The owner who has finished tracking and has published moments may log off of the service until next scheduled pet tracking session and the process ends at step 1013.

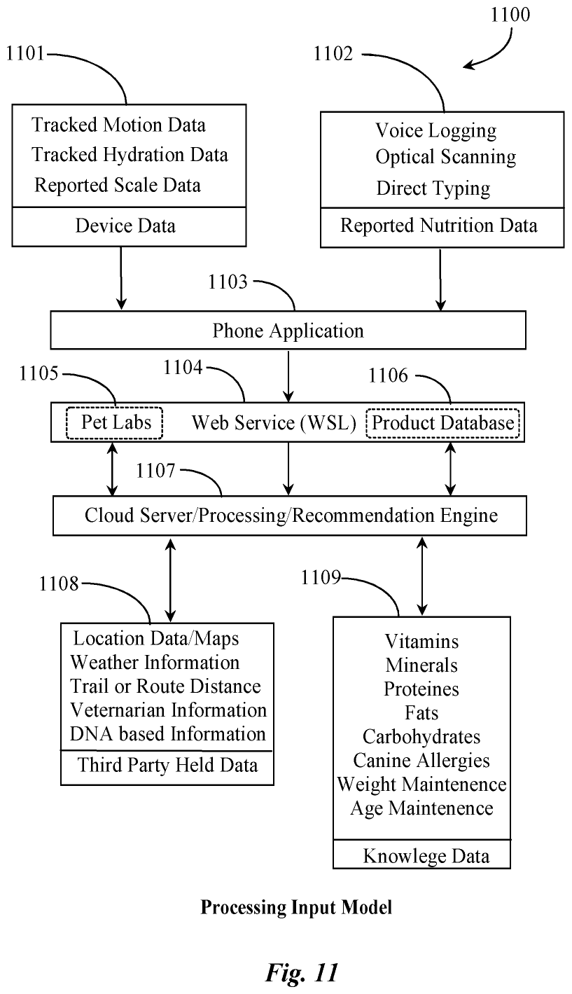

FIG. 11 is a block diagram depicting a processing input model 1100 according to an embodiment of the present invention. Processing input model 1100 represents the data access structure of the processing unit or system, which in this embodiment is a cloud service-based processing and recommendation engine 1107. Web service 1104 may call cloud services for data processing and generating intelligent recommendations and notifications for the client. AI applications may be used to interact with the pet owner through the mobile device and application of that owner. Input model 1100 includes device data 1101 comprising tracked motion data tracked hydration data, and reported scale data. Device data is accessed from the tracking devices by the owner connecting with a mobile device running the client application.

Input model 1100 includes reported nutrition data 1102 that may be input by a pet owner including voice logged data (IVR interaction with AI assistant), scanning bar code data (AI function) such as on pet foods, pet treats, or supplements, or typing or voice texting through a chat function or text function in the client application. Reported nutrition data may include any food or supplements fed to the pet that was not tracked by a tracking device. In a preferred embodiment all of the data tracked and supplemental is passed to a web service 1104 through a mobile phone client application 1103.

Web service 1104 may broker all communication between a pet owner and the cloud functions. Web service 1104 hosts pet labs 1105 containing all the previously tracked data in archive. Cloud processing and recommendation engine 1107 has access to pet labs data when processing data on behalf of an owner's pet. A pet lab history may include all of the pet data from beginning of service to present. The processing engine may take data from pet labs in comparison with newer data and make recommendations based upon those findings. For example, if a pet is gaining weight past it's goal weight recorded then a recommendation may be made to change the amount of food or the type of food to feed the pet. If gait data shows a pet with a limp in pet labs, newer information may reveal less of a limp or that the limp is gone. A notification may be sent to the pet owner that the limp is gone attesting to the efficiency of a glucosamine product the pet owner had purchased based on a previous recommendation and started the pet on it.

In one embodiment, a pet may be tracked while wearing one or more accessories worn by a pet for fitness or training such as band weights. Moreover, a pet may be harnessed to vehicle or may be carrying a pack. Data about those accessories may be submitted to the service so that when the pet is to be tracked with accessories or pulling a vehicle or carrying a pack, the wellness tracking system is informed of those and may access all of the specification data to take into account when processing tracked motion data and the like. If an animal such as a lead sled dog is tracked while pulling a sled harnessed to other dogs, the weight of the sled and load on the sled may be known to the system so that the system may calculate the effects of those work loads on the lead dog relative to heart rate, respiratory frequency, caloric burn rate, and hydration rate calculations. In another example, a dog pushing and riding a skate board may be tracked where the weight of the board, the work the dog has to do to push the board, and the friction of the board against the surface might be factors in calculation caloric burn over distance and time, for example.

Web service 1104 also contains a product database 1106 listing a variety of healthy pet foods and supplements to treat common pet ailments. Processing engine has access to the product database 1106 so that it may select products from the database and recommend them to pet owners based AI findings relative to results of processing. For example, the system might find gait data trending down relative to proper gait balance suggesting stiffness in one or more joints of the pet and may search database 1106 for products to recommend.

Processing recommendation engine 1107 has access to a large volume of knowledge data 1109 that may be assembled maintained and stored in at the cloud portion of the service. The knowledge data may include knowledge about vitamins, minerals, proteins, fats, carbohydrates, canine allergies, weight maintenance tips, age maintenance tips, general breed tips and may include articles, results of studies, recipes, bathing information, information about toxic substances, and the like. In one embodiment of the invention, web service 1104 has access to knowledge base information on demand through the cloud-based service. Articles about pet wellness and study results, for example, may be shared with pet owners through the client application at any time.

Processing recommendation engine 1107 has access to third-party held data 1108 from any cooperating third-party data system connected to the network and having portals, ports, or channels for data access. Processing recommendation engine 1107 may have unfettered access to location information, maps and associated data, weather information data, trail or route distance information and map data, veterinarian information, and DNA based information. Third-party data sources may include local weather servers, mapping servers, advertising vets, advertising DNA services for pets, and other acceptable third-party ad data that might be recommended to pet owners. Pet products not relative to food or supplements may also be offered through advertisement to pet owners for their pets. Advertisements may be selected for owner's based on the breed they are tracking.

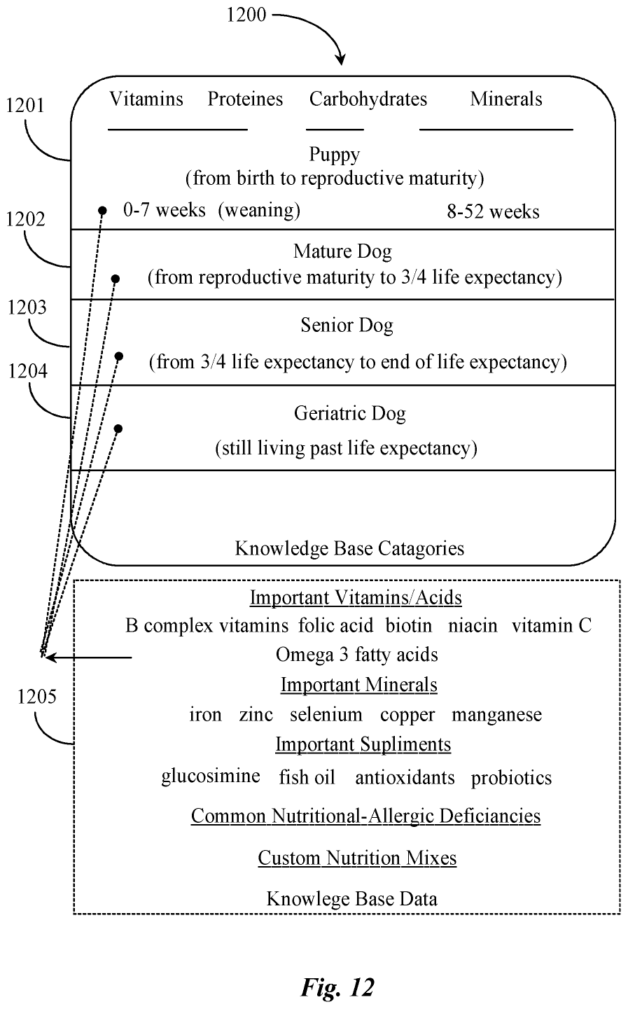

FIG. 12 is a block diagram 1200 depicting an exemplary knowledge base and exemplary knowledge base categories of held data. Diagram 1200 depicts a knowledge base data repository 1205. Knowledge base 1205 is analogous to knowledge base 121 of FIG. 1. The recommendation engine has access to knowledge about pets and pet nutrition. Knowledge base 1205 includes current data about important vitamins and nucleic acids for pets, in one example, for dogs, and includes data about B complex vitamins, folic acid, biotin, niacin, vitamin C, and Omega 3 fatty acids. Knowledge base 1205 may contain knowledge about important minerals for pets (dogs in this example). Knowledge base 1205 contains current data about iron, zinc, selenium, copper, and manganese.

A pet owner may scan in a bar code of a dry weight dog food and request an assessment from the service of whether to add supplements to the food or not and if so what type of supplements should be included. The service has access to all of the pet information supplied by the owner and has access to all of the data in owner/pet labs and may retrieve the information needed to support a recommendation of what supplements could be required for a pet in addition to their stock food. A pet owner may be recommended a supplement or supplements for their pet based on the data analysis of what's in the dry weight food compared to an overall template of what the pet requires for daily allowance or otherwise healthy levels with no deficiencies. The knowledge base has access to knowledge about pet food supplements such as glucosamine, fish oil, antioxidants, and probiotics.

Knowledge base 1205 includes data about common nutritional allergic deficiencies in pets including food allergies and the like. Knowledge base 1205 may also include custom nutritional products and recipes that have been created for pet owners based on their own registered pet data. Some of these custom recipes might be recommended to other pet owners having the same or similar breed pets with the same conditions lending to the need to provide a custom mix of nutrition. In most instances a supplement will be fine for most dogs, for example, but there may be dogs that the supplement could hurt if they are allergic to something in it. Therefore, the service can do an analysis and make sure that a specific supplement recommended will also be completely safe for the pet.

Knowledge base categories 1200 may be adjusted according to growth stages of a pet as certain vitamins, minerals, and other nutrients may be more critical in one stage but not required or not as important in another stage. For example, with dogs food is made for puppy stage, adult stage, and senior stage. In one embodiment, knowledge base 1205 contains such categories, in this case a more pertinent breakdown of a dog's development through life. For example, a category 1201 references a puppy stage generally defined as the time from birth to sexual maturity. Additionally, it includes wean 0 to 7 weeks and post wean 8 to 52 weeks. Specific vitamins, proteins, carbohydrates and minerals may be more important for a dog in the puppy stage. A next stage 1202 is mature dog. A mature dog is an adult from maturity to about three fourths of the dog's life expectancy. A next stage 1203 is senior dog. A senior dog is generally defined as a dog past three fourths of their life span up to the general life expectancy. A final stage 1204 is geriatric. Geriatric is generally defined as a dog still living past the life expectancy.

The appropriate mix for dog food and supplemental minerals and nutrients will be different for each one of stages 1201 through 1204. In one embodiment, a pet owner who is not sure of the life expectancy of a pet may have the service calculate the life expectancy of the registered pet based upon the available breed information. If a pet owner obtains a rescue and does not know how old the pet is, tracking with the gait analysis feature on may enable the system to analyze the gait of the pet to see the stance, height, and balance of the pet while walking and running. The service may also take into account the endurance of the pet (steps or strides) along a moderate to long distance. The pet owner may also submit a photo of the dog's teeth into the service through the application wherein the service can analyze the photo and estimate the dog's age.

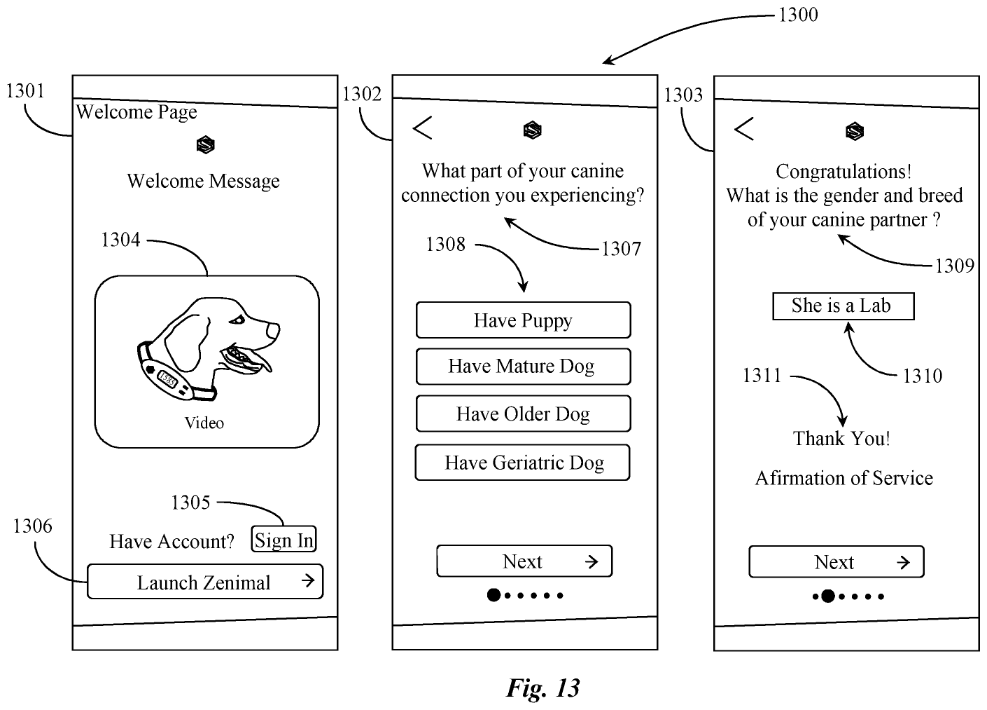

FIG. 13 is a block diagram depicting first series of exemplary screen shots 1300 of the client application 113 of FIG. 1 enabling interaction in getting started with the service of the invention. When a pet owner registers a dog for tracking they may receive a welcome page 1301 in their client application running on the owner's connected mobile device. In one embodiment, a short orientation video 1304 may be included in welcome page 1301. If a pet owner has an account they may sign in to their account using option 1305. The pet owner may launch Zenimal using option 1306 to continue to a next screen 1302. Screen 1302 may include one or more questions to the pet owner like a question 1307 with selectable options 1308 presented below for interactive selection. Question 1307 asks what part of the canine connection the pet owner is experiencing. Selectable options 1308 include puppy, mature dog, older dog, and geriatric dog.

If the pet owner is not sure of age, the service may help as was described further above. It is also noted herein that the example in this embodiment is of a dog. However, the present invention is not limited to dogs but may be applied to other pets or domestic animals that owner's are responsible for taking care of. The inventor embodies the example of a pet dog due to the fact that dogs are the most probable and popular pets that owner's spend time walking, exercising, jogging, or riding a bike with. The pet owner may continue on to the next screen 1303 by selecting next on screen 1302.

The service may affirm the pet owner by sending a congratulatory note 1309 that may also ask another question such as what the gender and breed is of the owner's pet. A text entry box 1310 might be provided for the pet owner to type the gender and breed such as she is a Labrador retriever or lab for short hand. Other basic get to know your pet questions may include the pet's name, color of coat, etc. The pet owner may also submit one or more photos of their pet for profile purposes. After basic questions, the service may provide an affirmation of service statement and a thank you 1311.

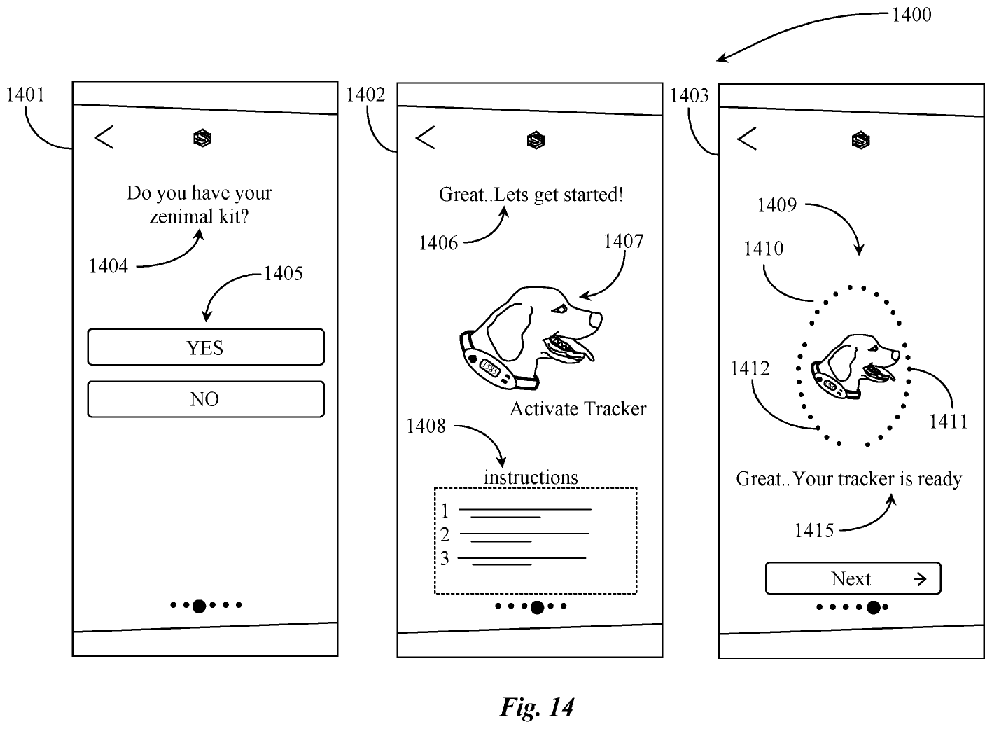

FIG. 14 is a block diagram depicting a second series of exemplary screen shots 1400 of the phone application of FIG. 1 further enabling the same interactive process. Screen shots 1300 include screen 1401 continued from the interaction in screen 1303 of FIG. 13. Screen 1401 asks the pet owner if they have the Zenimal kit, more particularly, the tracker device in question 1404. The pet owner may select from options 1405 yes or no to answer the question. Once enough data is submitted to enable smart tracking, on the next screen 1402, the service may provide a text confirmation 1406 urging the pet owner to get started with tracking. A pet owner may select icon 1407 to activate the pet tracking device for service. The service may provide instructions 1408 to the pet owner relative to charging and placing the tracking device on their pet.

A next screen 1403 depicts a data set 1409 including a profile picture 1411 of the Owner's dog breed wearing the tracking device. The pet owner may update profile picture 1411 with an actual photo of their dog wearing the tracking device. Although there are other methods of depicting these types of progressive data such as bar graphs and such the following is for example only and the depiction of progress in any of the areas below may use different methods. Data includes a first array of dots 1410, a second array of dots 1411, and a third array of dots 1412 where the dot arrays each represent a different data point for tracked data results. In an array, each dot represents a unit of measure for a specific type of result, for example, array 1410 may represent number of steps or strides or feet in distance a tracked pet has achieved. Each dot may be calibrated to represent an equal number of steps, strides, or feet tracked.

There are ten dots in array 1410 and the dots may change color as they are filled by tracked data. For example, if a dog walks 500 steps and each dot represents 250 steps, then two dots may change color to indicate the current number of steps the dog has tracked. The entire array 1410 represents 2500 steps, strides, or feet. The unit of measure need not be relative to a dog's actual footsteps because a dog has four feet and a very small dog executes many footsteps in a short distance. Therefore, data display 1409 may be configured by the owner to express units as strides, steps, feet (distance), yards (distance) or other units of measure such as metric units of measure. In one embodiment a dog owner may also use GPS (or a known distance) to calculate a dog's steps by traveling the known distance and recording the steps from a pedometer.

Data dot array 1411 may represent total liquids consumed in ounces or other units of measure. On a long hike where no natural water may be present a dog may drink from the pet owner's smart bowl (device 112b FIG. 1). Data dot array 1412 may represent total calories burned (a calculation made at the service). Data display 1409 may be configured to show total numbers tracked at one time such as on a dog walk. The pet owner may also look at data for two hikes, for a week, for one month, etc. Data display is simply a fast summary of result data that may appear on a home page of the client application. The pet owner may also browse the tracked data in the pet owner's labs back to a limit set by the service or back to the first tracked data.

Data points in tracked data may include but are not limited to weight, steps or distance, calories burned, food consumed, liquid consumed, and supplements. Pet/owner labs may be searched by the owner for before and after data that is dated. Other data points may include a list of current food and supplements including vitamins minerals and carbohydrates the dog is currently taking on a regular basis. In one embodiment, where a pet is taking medications, record of what medicines and when they were to administered may be input into pet/owner labs.

In one embodiment, a veterinarian (third party) may install an application program interface (API) on their data server connected to the network to enable vet records and data for an owner's registered pet to be forwarded from the third party vet service to the cloud service for processing and update to pet/owner labs. The service may send confirmation 1415 that the pet owner's tracking device is activated registered and ready to track data.

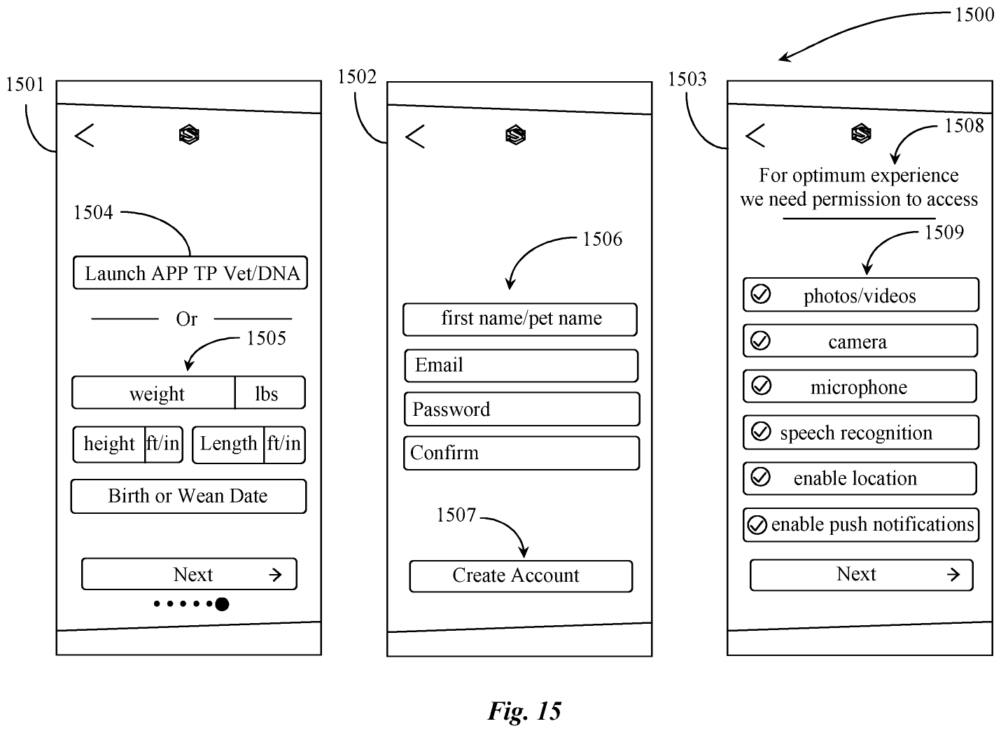

FIG. 15 is a block diagram depicting a third series of exemplary screen shots 1500 further enabling the same interactive process. Screen shots 1500 include screen 1501 asking further questions from the pet owner. In one embodiment, the pet owner may launch a third-party application 1504 that enables redirection of third-party data held for the pet owner to the service for inclusion to the pet/owner labs data. Third-parties may send or otherwise make available to the service, veterinary records and vaccination/shot schedule while a Canine DNA service may send DNA information already processed for the owner's pet. If descriptive data has not been received the service may present form 1505 for the owner to type in any pertinent information such as weight, height, and length of their pet and the birth or wean data if known for age calculation. Any other data revealing age, weight, etc. already known to the service may be inserted into the form fields as system inserted data ahead of owner input. A next screen 1502 may include the service form 1506 asking for owner first name and pet name, owner email address, owner password, and owner confirm password. The pet owner may create the account by selecting option 1507. Once the account is created and the tracker activated, the owner may practice the invention by tracking their pet and interacting with the service to optimize the experience for themselves and their pet. A next screen may request permission to access to certain data and media files and or feature controls in the form of a service statement 1508.

A menu 1509 may be presented listing the functions or features installed on the owner's mobile device for which permissions to access might be requested. The pet owner may interact with each one and check whether permission is granted or no such as access ON/OFF. In this way the service may access time stamped media files and aggregate those for the pet owner to share as moments on the instant platform or on a social media platform the owner subscribes to. List 1509 includes options for allowing the service to access photos and videos, camera function, microphone function, speech recognition application, location services, and push notifications.

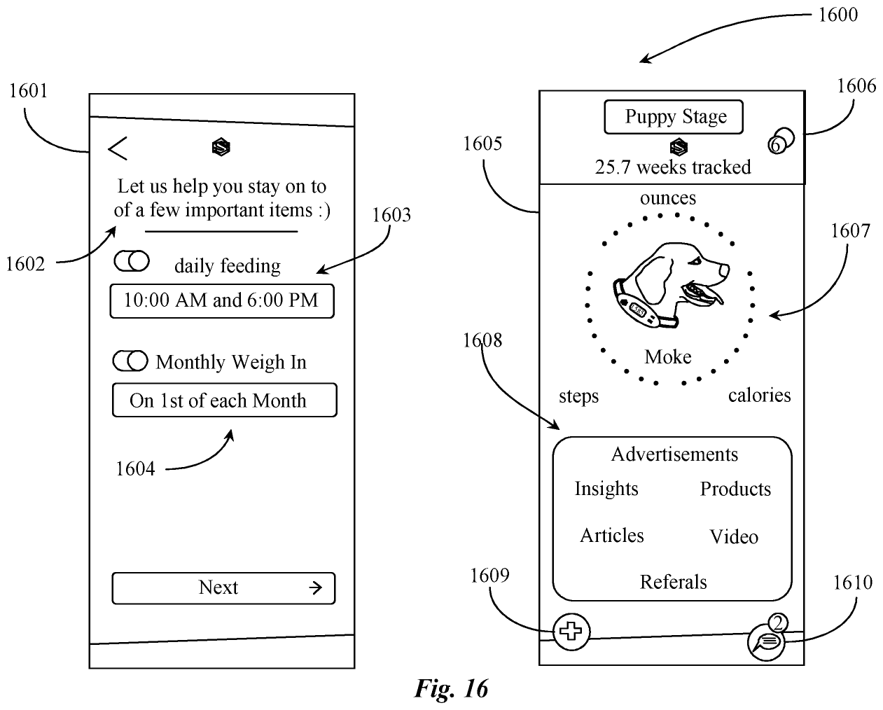

FIG. 16 is a block diagram depicting a fourth series of exemplary screen shots 1600 displaying feeding and weigh-in schedule reminders and a home screen depicting total results data, total time tracked, and other interactive links to other useful data and advertised products. Screen shots 1600 include a screen 1601 that presents a list of common tasks the pet owner may have relative to their pet and may present a request 1602 to the pet owner to select and or confirm a daily feeding schedule 1603 for example.

The pet owner may type in preferred morning and evening feeding times and accept reminders from the service so they do not forget to feed their pet. In one embodiment, the service will present a monthly weigh in schedule 1604 for the pet owner to set regular weigh-ins for their pet and to get reminders before each periodic weigh in. Other tasks may also be added such as regular pet grooming schedule, etc.

A next screen 1605 may be a home summary page or screen that shows the pet owner any current data and through which notifications and the like might be received. Screen 1605 has a top portion or bar window 1606 that reveals the pet is still in puppy stage and has, in this example, been tracked for a total of 25.7 weeks. Tracked data is processed to produce data results in at least three categories for a summary review interactive presentation 1607. Presentation 1607 includes the total amount (data dot array) for ounces of liquid, steps or strides or distance tracked and calories burned. Knowledge of calories burned and calories consumed enables a pet owner to manage the weight gain of their pet.

Screen 1605 includes an advertising window 1608. Advertising window 1608 may include advertisements for products from trusted third parties, advertisements for first party-controlled products, professional insights for pet owners in the form of articles, news, and video or audio media, and first party referrals to third party products or services like pet insurance, DNA services, vet services, add so on. The owner may click any of the links in box 1608 for more information.

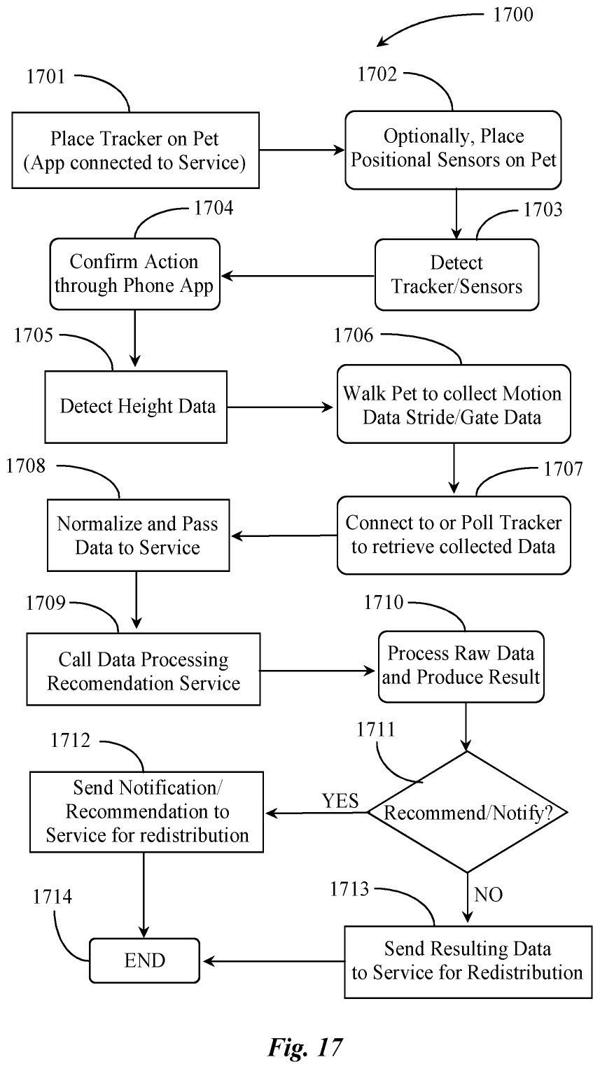

FIG. 17 is a process flow chart 1700 depicting steps for processing collected data and processing the data for results and recommendations or notifications. Before a hike or a run with a pet, the pet owner may place a tracking device on the collar 201 of the pet at step 1701. In this step and throughout this process it is assumed that the pet owner is connected to the service through the mobile device hosting the client application. At step 1702, the pet owner may optionally place two or more positional sensors on the pet like sensors 204 and 205 of FIG. 2B. The positional sensors may communicate to the parent tracking device or directly to the owner device.

At step 1703, the pet owner may detect the tracking device(s) (wireless network connection) and may confirm the action through the client application at step 1704. In one aspect of the general process, some information about the pet may simply be obtained by the service through the first tracking data. At step 1705, the service may ascertain the pet's height data (from ground to device on collar) and the pet's body length from front leg to rear leg. At step 1706, the pet owner may walk the pet for a distance to collect motion data including stride length and gait data (with positional sensors). At step 1707, the pet owner may poll the tracking device(s) to retrieve the collected data. In one embodiment, the data is offloaded from the tracking device (s) immediately after recorded and sent to the owner's mobile device in real time. The tracking device may retain data in cache for a period before purging the data that has successfully been transferred.

Once the pet owner has enough data to send to the service, the data may be normalized if required and sent to the web service for process at step 1708. The web service may function as a proxy between the owner and cloud services. Once the data is at the web service, the web service may call for cloud processing at step 1709 on behalf of the pet owner. The cloud service may analyze and process the data to result data at step 1710. At step 1711, the recommendation engine may determine whether there needs to be any recommendations or notifications sent back with result data.

If the recommendation service concurs at step 1711 that no notifications or recommendations are required, then the resulting data may be sent back to the web service for distribution to the client at step 1713. The process then may move to end at step 1714 for that batch of data. The height, length, and gait data may help the system to predict or narrow breed categories for a pet owner trying to guess. If the recommendation engine determines to generate and send a notification or recommendation at step 1711, the cloud service may send the notifications and or recommendations back to the web service for redistribution at step 1712 and the process ends for that batch of data at step 1714.

Tracking a pet before answering questions about the pet may reduce work for the pet owner relative to manual data input. Knowing the height and length and wide stance of the pet may allow the system to narrow breed possibility and guess weight of the pet. If the breed is known then the guess weight may be more accurate.

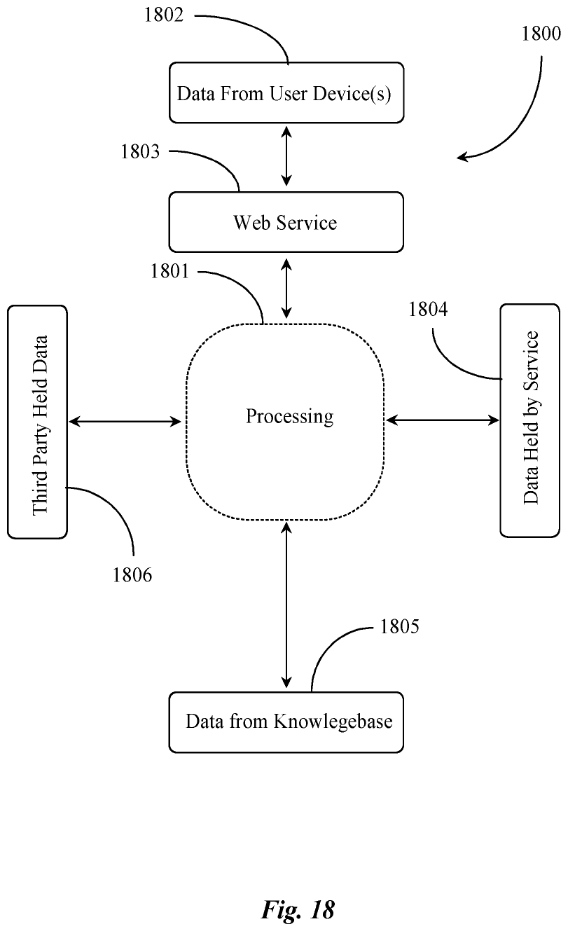

FIG. 18 is a block diagram 1800 depicting processor access to data over the fulfillment network. At the center of diagram 1800 is a cloud based processing entity 1801. Entity 1801 is analogous to processing and recommendation engine 1107 of FIG. 11, which in turn is analogous to servers 106 and 107 of FIG. 1 hosting SW instances 122 and 123 respectively. Processing may be performed on a central piece of hardware or on a distributed platform consisting of two or more processing entities networked together without departing from the spirit and scope of the present invention. Processing entity 1801 has bi directional network support for communicating and exchanging data with a web service 1803 functioning as a proxy service in this embodiment between the pet owner device and the cloud processing and recommendation service. Block 1802 represents data from user (pet owner) devices. All data from devices goes to the web service before data may be processed for results and recommendations or notifications.

Processing entity 1801 may access data from a knowledge base 1805 that may, in one embodiment, also be held in the cloud. Knowledge based data may be accessed to obtain information that may be relative to data results after initial processing and may be accessed by the recommendation/notification portion of the overall processing. The knowledge base may be accessed upon finding a result that may qualify under processing rules to access more information for the purpose of recommending a solution to a pet owner or notifying a pet owner of a possible problem or developing condition. If a notification is sent to a pet owner describing a problem, one or more recommendation may also be sent that portend to a possible solution.

Processing entity 1801 has bidirectional access to data held by the web service represented herein as block 1804. Processing entity 1801 also has bidirectional access to third-party held data represented herein as block 1806. Web service held data includes any data that the web service has logged for a pet owner with the exception of password data and financial information. Third-party held data 1806 includes any third party information available that may be useful in processing pet tracking data and predicting conditions for scheduled pet tracking sessions.

Processing entity 1801 may during processing of a request from the web service on behalf of a pet owner may access any of the connected data sources at any time. Such access may be triggered by a request, triggered by an anomaly in tracked results, or performed by default without departing from the spirit and scope of the present invention. Processing entity 1801 may be active for a pet owner for continued batch data processing or near real time data processing and recommendation and notification for a duration of a pet tracking session. Alternatively processing entity 1801 may be active for a pet owner for processing data submitted after a tracking session has completed.

In one embodiment, the pet owner may configure the nature of processing by turning on or off processing features from within the local client application running on the pet owner's mobile device, by selecting from processing options including but not limited to continuous processing (real time during session) batch processing (periodic batch processing during session), or post session processing (one processing event post session for all session data). Processing entity 1801 may be accessed on demand on behalf of an active pet owner for specific purposes like predictive analysis. In one embodiment the service records parameters about a pet by detecting them through tracking device arrangement on the pet (positional) and function including motion tracking and at least basic gait analysis.

Web service 1803 has transactional means to enable pet owners to make secure transactions through the client application running on their mobile devices. Recommendations made to pet owners may result in product orders for new products or adjustments in existing blanket product orders. A blanket order is an order that results in periodic shipments of a same product with payment usually due after each shipment is received. Web service 1803 may control which entities may be approved to provide nutritional products including food and supplements that may be recommended in specific nutritional mixes for pet owners. Likewise, web service 1803 may also control which entities may be approved to provide medicinal products, pet toys, DNA services, pet consumables like training pads, liter, tooth paste, and pet apparel products.

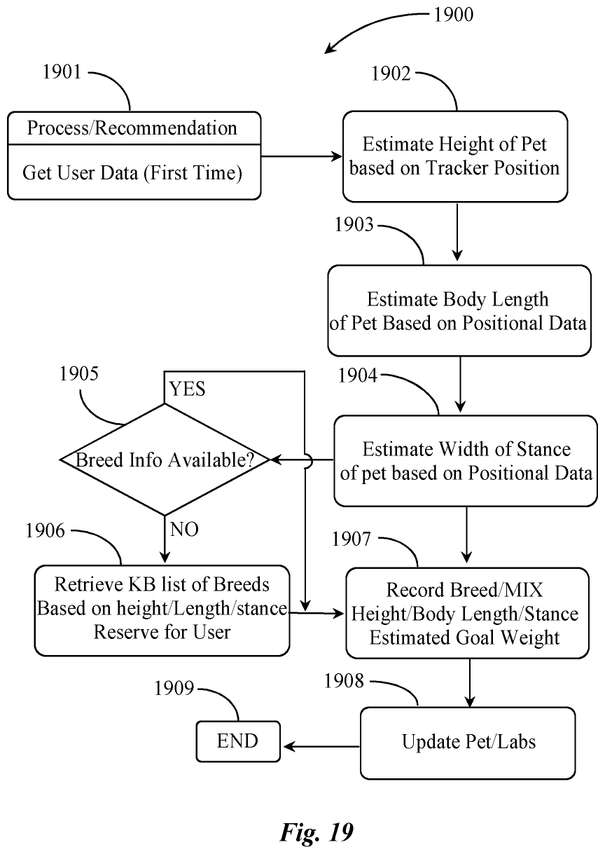

FIG. 19 is a process flow chart 1900 depicting steps for predictive analysis based on data to help establish breed according to an embodiment of the present invention. At step 1901, it is assumed that the pet owner has submitted device data to the web service for the first time tracking a pet (tracking device(s) active) where the details about the pet are yet unknown to the web service. In step 1901 the web service gets the data from the pet owner device(s) and forwards that data to the web service, where the web service has, in turn, called for cloud-based processing of the data. At step 1902, the processing entity may estimate the height of the pet based on the positioning of the tracking device(s) placed on the pet. At step 1903, the processing entity may estimate the length of the pet based on positional data (front and back alternate legs).

At step 1904, the processing entity may estimate the width of stance of the pet based on calculation of positional data. At step 1905, the processing entity may look for breed information if available. Breed information may have been previously reported to the web service by the pet owner where the processing entity has access to that data. If at step 1905, the processing entity finds the breed/mix information, the process may move ahead to step 1907. At step 1907, the processing entity may record the breed/mix, height dimension, length dimension, width of stance dimension, and may record the calculated goal weight of the pet according to a healthy model. The processing entity may update pet labs at step 1908 by sending the results to the web service brokering the interaction. The process may end for that session at step 1909.

If at step 1905, the processing entity has no breed information, the process may include step 1906 where the processing entity may retrieve from the knowledge base, for example, a list of possible breeds based on the dimensional information developed as many breeds will not fit the profile and may be ignored. In pet labs updating, the web service may make the breed list retrieved at step 1906 available in pet labs so the pet owner may select one or a mix of two breeds for example through the client application on the mobile device. In this aspect, the “goal weight” may not be the actual weight of the pet but may represent a desired weight or goal weight the owner might strive to obtain on behalf of the pet.

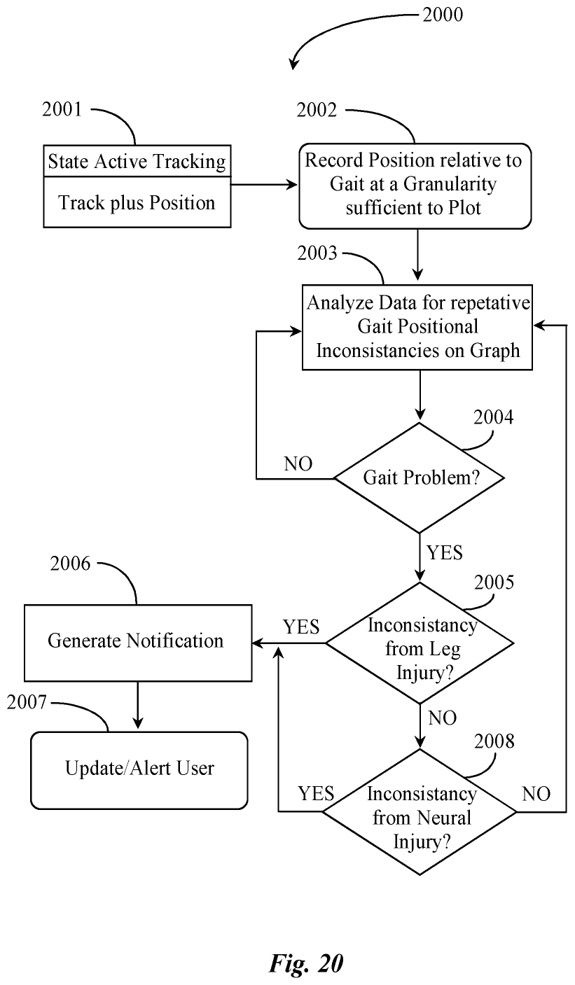

FIG. 20 is a process flow chart 2000 depicting steps for determining an issue through gait analysis of a pet and alerting the pet owner. At step 2001, it is assumed a pet is in an active state of tracking with a collar tracking device like device 112a of FIG. 1, and at least two positional sensors like sensors 204 and 205 of FIG. 2B. At step 2002, the devices record motion and position over time and distance relative to gait of the pet in sufficient granularity to plot (cloud process) a basic gait pattern for the pet.

The processing entity analyzes data looking for repeated inconsistencies in the gait pattern or graph. At step 2004, the processing entity may determine if there is a current gait problem. If at step 2004, no problem is detected the process may loop back to step 2003 for further analysis or until tracking data is not available (session over). It is noted herein that the processing may occur near real time for a pet owner wishing to check or validate the gait of their pet. In another embodiment the session may be collected and the data sent in for processing at a later time.

If at step 2004, the processing entity recognized a gait problem, then at step 2005 more calculation may ensure to determine the type of repetitive issue. For example, is it an inconsistency likely to be from an injury to a leg or paw? If so the recommendation/notification engine may generate a notification at step 2006 summarizing the issue detected including data about how it was determined and any links or recommendations for any actions. At step 2007, the web service may update or alert the pet owner by push notification if the pet owner is connected through the smart phone aided by the client application.

If at step 2005, it is not flagged to a physical leg or foot injury causing the inconsistency in gait, the system might determine at step 2008 whether the abnormal gait pattern may be neurological for example. Random seizures or other neurological reactions in a pet may affect the gait pattern. If it is determined that the inconsistency may be neurological, the process moves to step 2006 and then step 2007. If it is determined that it can't be pin pointed at step 2008, the process may loop back to step 2003 for further analysis of data until such data is not available (session over). In one aspect, the system may also confirm to a pet owner in a notification that the gait analysis detected no abnormal gait inconsistencies.

It may be apparent to one with skill in the art that a pet owner may register more than one pet for tracking, each pet having a separate identity in profile and a personal pet/owner labs without departing from the spirit and scope of the invention. It may also be apparent that with separable network addressing and unique device registration, more than one pet may be tracked in a single tracking session without departing from the spirit and scope of the invention. While this writing uses a dog as a preferred example of a pet, the term pet may equate to other types of pets including domestic animals without departing from the spirit and scope of the present invention. In one embodiment of the invention, the knowledge base may support a variety of animals that may be tracked and monitored using a tracking and reporting device lending application to commercial application for zoos, farms, ranches, and potentially wildlife managers.

It will be apparent to one with skill in the art that the pet tracking, reporting, and fulfillment system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

For example, commercial applications can be practiced such as tracking a dog through a professional dog show, tracking domestic animals, tracking show animals in training such as a horse, for example. There are many commercial possibilities.

It will further be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A pet wellness tracking system comprising:
at least one electronic tracking device secured to a pet, the tracking device having wireless data transfer capability to transfer data to a second electronic device;
a first set of coded instructions on a non transitory medium coupled to or otherwise hosted by the at least one tracking device, the instructions causing the device when powered on to record at least motion data of the pet over time and transfer the data in a push mode or in a pull mode to the second device;
at least one first electronic volume measurement device secured to or otherwise fitted to a feeding bowl and or watering bowl, the volume measurement device having wireless data transfer capability to transfer data to the second electronic device;
a second set of coded instructions on a non-transitory medium coupled to or otherwise hosted by the at least one volume measurement device, the instructions causing the device when powered on to record at least volume data of the contents in the bowl over time and transfer the data in a push mode or in a pull mode to the second device;
a second electronic volume measurement device having wireless data transfer capability to transfer data to the second electronic device;
a third set of coded instructions on a non-transitory medium coupled to or otherwise hosted by the second electronic volume measurement device, the instructions causing the device to record volume data of the pet standing or sitting on the device and transfer that data in a push or a pull mode to the second device; and
a fourth set of coded instructions on one or more non-transitory mediums coupled to or otherwise hosted by one or more servers on a data network accessible to the second device through network access capability, the instructions causing the one or more servers to receive the recorded data from the second device over the network, process that data in light of other available data, and return data results, notifications and recommendations to a network location accessible to the second device;

2. The pet wellness tracking system of claim 1, wherein the network is the Internet network and the wireless transfer network is one of a Bluetooth™ network, a wireless fidelity (WiFi) network, or a wireless carrier network (WCN).

3. The pet wellness tracking system of claim 2, wherein the pet is a dog.

4. The pet wellness tracking system of claim 2, wherein at least one electronic tracking device attaches to the dog collar and tracks at least motion, time of motion, and elevation.

5. The pet wellness tracking system of claim 4, wherein there are two additional tracking devices, one worn on an upper front leg, and one worn on an upper hind leg and track at least motion and position relative to one another.

6. The pet wellness tracking system of claim 1, wherein the at least one first electronic volume measurement device is an electronic scale that records weight of food or water in the bowl and tracks volume loss over time.

7. The pet wellness tracking system of claim 1, wherein the second device is a smart phone operated by the pet's owner, the smart phone capable of network access and browser-based access to network resources.

8. The pet wellness tracking system of claim 7, wherein the network location is a pet lab data archive hosted by a web service the pet's owner subscribes to.

9. The pet wellness tracking system of claim 8, wherein the pet owner accesses pet lab data through the smart phone and a browser-based application.

10. The pet wellness tracking system of claim 1, wherein processing consults third-party held data and or resident knowledge based data before finalizing results, notifications, and recommendations to be returned.

11. The pet wellness tracking system of claim 1, wherein the second electronic volume measurement device is a biometric-capable digital weigh scale.

12. The pet wellness tracking system of claim 1, wherein recommendations include introductions to nutritional food mixes, supplements, or other products, the recommendations including at least one executable network link to a least one secure transactional web interface for purchasing a product or service.

13. The pet wellness tracking system of claim 1, wherein the network access capability of the second device is a wireless Internet capability.

14. The pet wellness tracking system of claim 1, wherein some results are returned after analysis of gait data of the pet.

15. The pet wellness system of claim 14, wherein a predicted result is a goal weight of the pet.

16. The pet wellness tracking system of claim 1, wherein the first volume measuring device supports a stock bowl placed thereon or fitted therein and calculates the weight of the empty bowl subtracting that weight from total weight to report correct volume of contents.

17. The pet wellness tracking system of claim 16, wherein the stock bowl is supported by a rim around the top of the first volume measuring device, the bottom surface of the bowl contacting the scale surface of the first volume measuring device within the physical rim boundary.

18. The pet wellness tracking system of claim 16, wherein the stock bowl is supported by a three or more adjustable arm stops mounted to the annular surface of the first volume measuring device in equally spaced pattern and wherein the bowl is placed down on the scale surface of the first volume measuring device while the stops are adjusted to make contact above the plane of the scale surface to keep the bowl in place on the first volume measurement device.

19. The pet wellness tracking system of claim 1, wherein the first volume measuring device further includes at least one motion sensor that detects the vibrations made by a pet eating or drinking, the detection thereof in low power mode cause the device to boot to normal operation.

20. The pet wellness tracking system of claim 1, wherein other data includes product data describing one or more accessories worn by a pet or harnessed vehicle attached to a pet.
